(19) United States
(12) Patent Application Publication
(10) Pub. No.: US 2023/0133886 A1
(43) Pub. Date: May 4, 2023

(54) METHOD FOR PROVIDING BATTLE ROYALE GAME BASED ON A PLURALITY OF CLASSES AND SERVER USING THE SAME

(71) Applicant: Wonder People Co., Ltd., Seoul (KR)

(72) Inventor: Min HUR, Seoul (KR)

(21) Appl. No.: 17/975,101

(22) Filed: Oct. 27, 2022

(30) Foreign Application Priority Data
Nov. 3, 2021 (KR) 10-2021-0150132
Jun. 16, 2022 (KR) 10-2022-0073830

(51) Int. Cl. A63F 13/49; A63F 13/35; A63F 13/837

(52) U.S. Cl. CPC A63F 13/49; A63F 13/35; A63F 13/837

(57) ABSTRACT

A method of providing a battle royale game is based on a plurality of classes. The method includes steps of: acquiring a game participation request for the battle royale game from a specific user device, determining initial selectable classes, instructing the specific user device to perform one of a (1_1)-st process of selecting a specific initial selectable class among the initial selectable classes and a (1_2)-nd process of selecting the specific initial selectable class by using a predetermined first function with the initial selectable classes and their corresponding initial selectable probabilities as arguments, and applying the specific initial selectable class to a specific player corresponding to the specific user device.

### CROSS REFERENCE TO RELATED APPLICATION

This application claims the benefit of priority to Korean Provisional Patent Application No. 10-2021-0150132, filed on Nov. 3, 2021, and Korean Non-provisional Patent Application No. 10-2022-0073830, filed on Jun. 16, 2022, the entire contents of which being incorporated herein by reference.

### FIELD OF THE DISCLOSURE

The present disclosure relates to a method for providing a battle royale game and a server using the same; and more particularly, to the method for providing the battle royale game based on a plurality of classes, and the server using the same.

### BACKGROUND OF THE DISCLOSURE

Numerous battle royale games which can be played by multiple users at the same time are recently being released and are gaining popularity steadily from the users.

Such battle royale games are allowing the multiple players to compete for survival to be a final winner in a restricted space, and the users feel interest in preoccupying geographical advantages and items and establishing appropriate strategies or tactics according thereto, thereby overpowering competitors.

However, the players participating in the conventional battle royale games all have same abilities (e.g., physical abilities).

Accordingly, as there are no differences in the abilities among the players, the players participating in the battle royale games had to search for items better than those owned by their competitors in order to be the last survivor and ultimately win.

Also, the players participating in the conventional battle royale games had established strategies of avoiding battles with their competitors as much as possible to not be vainly robbed by their competitors of the items they have worked hard to collect.

As such, there is a problem of the users of the battle royale games losing interests because of simplified game-winning strategies such as strategies of avoiding battles and collecting items.

Accordingly, a configuration for solving the problems above is demanded in this situation.

### SUMMARY OF THE DISCLOSURE

It is an object of the present disclosure to solve all the aforementioned problems.

It is another object of the present disclosure to provide a battle royale game based on a plurality of classes by assigning each class to each player participating in the battle royale game.

It is still another object of the present disclosure to allow each user participating in the battle royale game to break away from a uniform strategy centered on item collection, and to induce frequent battles.

It is still yet another object of the present disclosure to enable each user of the battle royale game to continuously have interest in the battle royale game.

In order to accomplish objects above and characteristic effects to be described later of the present disclosure, distinctive structures of the present disclosure are described as follows.

In accordance with one aspect of the present disclosure, there is provided a method of providing a battle royale game based on a plurality of classes, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, including steps of: (a) on condition that at least one of (1) a process of matching initial k-th predetermined maximum player information with a k-th class while varying k from 1 to n, wherein the initial k-th predetermined maximum player information includes information on a maximum possible number of k-th players belonging to the k-th player group that exist simultaneously in the first state of the battle royale game, thereby setting initial 1-st predetermined maximum player information to initial n-th predetermined maximum player information corresponding to a 1-st class to an n-th class, and (2) a process of matching each progressional k-th predetermined maximum player information for each game-progression degree with the k-th class, wherein the progressional k-th predetermined maximum player information includes information on each maximum possible number of the k-th players belonging to the k-th player group that simultaneously exist for each game-progression degree in the second state of the battle royale game, and wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, thereby setting progressional 1-st predetermined maximum player information to progressional n-th predetermined maximum player information corresponding to the 1-st class to the n-th class have been performed, a server acquiring a game participation request for the battle royale game from a specific user device, (b) on condition that the server has acquired at least part of 1-st standby player information to n-th standby player information in real-time, including k-th standby player information which includes a cardinal number of the k-th players belonging to the k-th player group in the first state, or at least part of 1-st surviving player information to n-th surviving player information in real-time, including k-th surviving player information which includes a cardinal number of k-th surviving players among the k-th players belonging to the k-th player group in the second state, the server performing one of a 1-st process and a 2-nd process, wherein the 1-st process performs processes of: (i-1) determining initial selectable classes by referring to at least part of the initial 1-st predetermined maximum player information to the initial n-th predetermined maximum player information and the 1-st standby player information to the n-th standby player information in the first state, wherein the initial selectable classes are at least part of classes other than initial saturated classes among the 1-st class to the n-th class, and wherein a j-th class is determined as one of the initial saturated classes when a cardinal number of players of j-th standby player information reaches initial j-th predetermined maximum player information, (i-2) instructing the specific user device to perform one of (i-2-1) a (1_1)-st process of selecting a specific initial selectable class among the initial selectable classes and (i-2-2) a (1_2)-nd process of selecting the specific initial selectable class by using a predetermined first function with the initial selectable classes and their corresponding initial selectable probabilities as arguments, and (i-3) applying the specific initial selectable class to a specific player corresponding to the specific user device, and wherein the 2-nd process performs processes of: (ii-1) determining currently changeable classes by referring to at least part of the 1-st surviving player information to the n-th surviving player information and 1-st predetermined maximum player information to n-th predetermined maximum player information corresponding to a current game-progression degree calculated by the progress calculating function in real time among the progressional 1-st predetermined maximum player information to the progressional n-th predetermined maximum player information in the second state, wherein the currently changeable classes are at least part of classes other tha currently saturated classes among the 1-st class to the n-th class, and wherein a j′-th class is determined as one of the currently saturated classes when a cardinal number of players of j′-th survival player information reaches progressional j′-th predetermined maximum player information (ii-2) instructing the specific user device to perform one of (ii-2-1) a (2_1)-st process of selecting a specific currently changeable class among the currently changeable classes and (ii-2-2) a (2_2)-nd process of selecting the specific currently changeable class by using a predetermined second function with the currently changeable classes and their corresponding currently changeable probabilities as arguments, and (ii-3) changing a class of the specific player to the specific currently changeable class.

As one example, at the step of (b), the server performs one of (i) the 1-st process of determining ml available initial selectable classes among the initial selectable classes by referring to a predetermined first algorithm in the first state, and performing one of (i-1) the (1_1)-st process of instructing the specific user device to select a specific available initial selectable class among the available initial selectable classes as the specific initial selectable class and (i-2) the (1_2)-nd process of selecting the specific available initial selectable class as the specific initial selectable class by using a predetermined third function whose arguments are the available initial selectable classes and their corresponding available initial selectable probabilities, to thereby apply the specific initial selectable class to the specific player, and (ii) the 2-nd process of determining m2 available currently changeable classes among the currently changeable classes by referring to a predetermined second algorithm in the second state, and performing one of (ii-1) the (2_1)-st process of instructing the specific user device to select a specific available currently changeable class among the available currently changeable classes as the specific currently changeable class and (ii-2) the (2_2)-nd process of selecting the specific available currently changeable class as the specific currently changeable class by using a predetermined fourth function whose arguments are the available currently changeable classes and their corresponding available currently changeable probabilities, to thereby apply the specific currently changeable class to the specific player.

As one example, at the step of (b), the server performs one of (i) the 1-st process of (i-1) determining m1-1 available initial selectable classes among the initial selectable classes by referring to a predetermined first algorithm in the first state, (i-2) in response to detecting that a re-determination request of selectable classes is acquired from the specific user device, checking whether a re-determination condition of selectable classes is satisfied by referring to (1_1)-st specific state information of the specific player, (i-3) in response to detecting that the re-determination condition for selectable classes is satisfied, determining m1_2 available adjustable selectable classes among the initial selectable classes by referring to the predetermined first algorithm, and (i-4) performing one of (i-4-a) the (1_1)-st process of instructing the specific user device to select a specific available adjustable selectable class among the available adjustable selectable classes as the specific initial selectable class and (i-4-b) the (1_2)-nd process of selecting the specific available adjustable selectable class as the specific initial selectable class by using a fifth function whose arguments are the available adjustable initial selectable classes and their corresponding available adjustable initial selectable probabilities, to thereby apply the specific available adjustable selectable class to the specific player, and (ii) the 2-nd process of (ii-1) determining m2_1 available currently changeable classes among the currently changeable classes by referring to a predetermined second algorithm in the second state, (ii-2) in response to detecting that a re-determination request of changeable classes is acquired from the specific user device, checking whether a re-determination condition of changeable classes is satisfied by referring to (1_2)-nd specific state information of the specific player, (ii-3) in response to detecting that the re-determination condition of changeable classes is satisfied, determining m2_2 available adjustable currently changeable classes among the currently changeable classes by referring to the predetermined second algorithm, and (ii-4) performing one of (ii-4-a) the (2_1)-nd process of instructing the specific user device to select a specific available adjustable currently changeable class among the available adjustable currently changeable classes as the specific currently changeable class and (ii-4-b) the (2_2)-nd process of selecting the specific available adjustable currently changeable class as the specific currently changeable class by using a predetermined sixth function whose arguments are the available adjustable currently changeable classes and their corresponding available adjustable currently changeable probabilities, to thereby apply the specific currently changeable class to the specific player.

As one example, at the step of (b), the server (i) in response to acquiring (1_1)-st process-related selection information corresponding to the (1_1)-st process from the specific user device, performs the (1_1)-st process and assigns a predetermined first penalty to the specific player, (ii) in response to acquiring (1_2)-nd process-related selection information corresponding to the (1_2)-nd process from the specific user device, performs the (1_2)-nd process and assigns a predetermined first reward to the specific player, (iii) in response to acquiring (2_1)-st process-related selection information corresponding to the (2_1)-st process from the specific user device, performs the (2_1)-st process and assigns a predetermined second penalty to the specific player, and (iv) in response to acquiring (2_2)-nd process-related selection information corresponding to the (2_2)-nd process from the specific user device, performs the (2_2)-nd process and assigns a predetermined second reward to the specific player.

As one example, at the step of (b), during the (1_2)-nd process, the server (i) selects the specific initial selectable class by using the predetermined first function whose arguments are the initial selectable classes and their corresponding initial selectable probabilities, (ii) in response to acquiring a class re-selection request from the specific user device, checks whether a class re-selection condition is satisfied by referring to (2_1)-st specific state information of the specific player, and (iii) in response to satisfying the class re-selection condition, selects a predetermined initial selectable class as the specific initial selectable class by using the predetermined first function, and wherein, during the (2_2)-nd process, the server (i) selects the specific currently changeable class by using the specific second function whose arguments are the currently changeable classes and their corresponding currently changeable probabilities, (ii) in response to acquiring a class re-change request from the specific user device, checks whether a class re-change condition is satisfied by referring to (2_2)-nd specific state information of the specific player, and (iii) in response to satisfying the class re-change condition, selects a predetermined currently changeable class as the specific currently changeable class by using the predetermined second function.

As one example, at the step of (a), on condition that the server has additionally performed at least one of processes of (i) setting a 1-st class perk to an n-th class perk corresponding to the 1-st class to the n-th class by matching a k-th class perk with the k-th class, wherein the k-th class perk is a special ability applied to the k-th players belonging to the k-th player group, (ii) setting a 1-st class ultimate skill to an n-th class ultimate skill corresponding to the 1-st class to the n-th class by matching a k-th class ultimate skill with the k-th class, and (iii) setting a 1-st class synergy item to an n-th class synergy item corresponding to the 1-st class to the n-th class by matching a k-th class synergy item with the k-th class, wherein the k-th class synergy item is an item that enhances any item used by the k-th players used within the battle royale game, the server acquires the game participation request from the specific user device, and wherein, at the step of (b), during the 1-st process, the server applies a g-th class, which is the specific initial selectable class, to the specific player to thus (i) determine at least one of (1) at least one specific g-th class perk selected by using a predetermined (7_1)-st function whose arguments are at least one g-th class perk and its corresponding g-th class perk probability corresponding to the g-th class, (2) at least one specific g-th class ultimate skill selected by using a predetermined (7_2)-nd function whose arguments are at least one g-th class ultimate skill and its corresponding g-th class ultimate skill probability corresponding to the g-th class, and (3) at least one specific g-th class synergy item selected by using a predetermined (7_3)-rd function whose arguments are at least one g-th class synergy item and its corresponding g-th class synergy item probability corresponding to the g-th class, and (ii) set at least one of the specific g-th class perk, the specific g-th class ultimate skill, and the specific g-th class synergy item to correspond to the specific player, and wherein, at the step of (b), during the 2-nd process, the server changes the class of the specific player to an h-th class, which is the specific currently changeable class, to thus (i) determine at least one of (1) at least one specific h-th class perk selected by using a predetermined (8_1)-st function whose arguments are at least one h-th class perk and its corresponding h-th class perk probability corresponding to the h-th class, (2) at least one specific h-th class ultimate skill selected by using a predetermined (8_2)-nd function whose arguments are at least one h-th class ultimate skill and its corresponding h-th class ultimate skill probability corresponding to the h-th class, and (3) at least one specific h-th class synergy item selected by using a predetermined (8_3)-rd function whose arguments are at least one h-th class synergy item and its corresponding h-th class synergy item probability corresponding to the h-th class, and (ii) change at least one of current class perk, current ultimate skill, and current class synergy item of the specific player to at least one of the specific h-th class perk, the specific h-th class ultimate skill, and the specific h-th class synergy item.

As one example, at the step of (a), on condition that the server has additionally performed at least one of processes of (i) setting a 1-st class perk to an n-th class perk respectively corresponding to the 1-st class to the n-th class by matching at least one k-th class perk with the k-th class, wherein the k-th class perk is a special ability applied to the k-th players belonging to the k-th player group, (ii) setting a 1-st class ultimate skill to an n-th class ultimate skill respectively corresponding to the 1-st class to the n-th class by matching a k-th class ultimate skill with the k-th class, and (iii) setting a 1-st class synergy item to an n-th class synergy item respectively corresponding to the 1-st class to the n-th class by matching a k-th class synergy item with the k-th class, wherein the k-th class synergy item is an item that enhances any item used by the k-th players used within the battle royale game, the server acquires the game participation request from the specific user device, and wherein, at the step of (b), during the (1_1)-st process, the server provides information on (i) an initial selectable class perk, among the 1-st class perk to the n-th class perk, corresponding to the initial selectable class, (ii) an initial selectable class ultimate skill, among the 1-st class ultimate skill to the n-th class ultimate skill, corresponding to the initial selectable class, and (iii) an initial selectable class synergy item, among the 1-st class synergy item to the n-th class synergy item, corresponding to the initial selectable class, to the specific user device, to thereby instruct the specific user device to select the specific initial selectable class by referring to at least part of the information on the initial selectable class perk, the initial selectable class ultimate skill, and the initial selectable class synergy item, and wherein, at the step of (b), during the (2_1)-st process, the server provides information on (i) a currently changeable class perk, among the 1-st class perk to the n-th class perk, corresponding to the currently changeable class, (ii) a currently changeable class ultimate skill, among the 1-st class ultimate skill to the n-th class ultimate skill, corresponding to the currently changeable class, and (iii) a currently changeable class synergy item, among the 1-st class synergy item to the n-th class synergy item, corresponding to the currently changeable class, to the specific user device, to thereby instruct the specific user device to select the specific currently changeable class by referring to at least part of the information on the currently changeable class perk, the currently changeable class ultimate skill, and the currently changeable class synergy item.

As one example, at the step of (b), during the (1_1)-st process, in response to receiving a request for standby player information from the specific user device, the server provides at least part of the 1-st standby player information to the n-th standby player information to the specific user device, to thereby instruct the specific user device to select the specific initial selectable class by referring to at least part of the 1-st standby player information to the n-th standby player information, and wherein, at the step of (b), during the (2_1)-st process, in response to receiving a request for surviving player information from the specific user device, the server provides at least part of the 1-st surviving player information to the n-th surviving player information to the specific user device, to thereby instruct the specific user device to select the specific currently changeable class by referring to at least part of the 1-st surviving player information to the n-th surviving player information.

As one example, at the step of (a), on condition that the server has performed processes of matching at least part of progressional k-th available item information and progressional k-th item performance information for each game-progression degree with the k-th class, wherein the progressional k-th available item information includes usable items of the k-th players for each game-progression degree and the progressional k-th item performance information includes performance information of the usable items of the k-th players for each game-progression degree, to thereby set at least part of progressional 1-st available item information to progrsesional n-th available item information and progressional 1-st item performance information to progressional n-th item performance information, the server acquires the game participation request from the specific user device, and wherein the method further includes a step of: (c) the server changing at least part of an item type and an item performance of the usable item within the battle royale game by referring to at least part of 1-st available item information to n-th available item information and 1-st item performance information to n-th item performance information corresponding to the current game-progression degree among the progressional 1-st available item information to the progressional n-th available item information and the progrsesional 1-st item performance information to the progrssional n-th item performance information.

As one example, at the step of (a), on condition that the server has additionally performed a process of setting at least part of progressional 1-st class perk information to progressional n-th class perk information, progressional 1-st class ultimate skill information to progressional n-th class ultimate skill information, and progrsesional 1-st class synergy item information to progressional n-th class synergy item information by matching at least part of each progressional k-th class perk information, each progressional k-th ultimate skill information, and each progrssional k-th class synergy item information with the k-th class, wherein the progressional k-th class perk information includes at least one k-th class perk applied to the k-th players for each game-progression degree in the second state, the progressional k-th class ultimate skill information includes at least one k-th class ultimate skill applied to the k-th players for each game-progression degree in the second state, and the progressional k-th class synergy item information includes at least one k-th class synergy item applied to the k-th players for each game-progression degree in the second state, the server acquires the game participation request from the specific user device, and wherein the method further includes a step of: (d) the server changing at least part of the 1-st class perk to the n-th class perk, the 1-st class ultimate skill to the n-th class ultimate skill, and the 1-st class synergy item to the n-th class synergy item within the battle royale game by referring to at least part of 1-st class perk information to n-th class perk information, 1-st class ultimate skill information to n-th class ultimate skill information, and 1-st class synergy item information to n-th class synergy item information corresponding to the current game-progression degree respectively among the progressional 1-st class perk information to the progressional n-th class perk information, the progressional 1-st class ultimate skill information to the progressoinal n-th class ultimate skill information, and the progressional 1-st class synergy item information to the progressoinal n-th class synergy item information.

In accordance with another aspect of the present disclosure, there is provided a server for providing a battle royale game based on a plurality of classes, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, comprising: at least one memory that stores instructions; and at least one processor configured to execute the instruction to perform or support another device to perform: (I) on condition that at least one of (1) a process of matching initial k-th predetermined maximum player information with a k-th class while varying k from 1 to n, wherein the initial k-th predetermined maximum player information includes information on a maximum possible number of k-th players belonging to the k-th player group that exist simultaneously in the first state of the battle royale game, thereby setting initial 1-st predetermined maximum player information to initial n-th predetermined maximum player information corresponding to a 1-st class to an n-th class, and (2) a process of matching each progressional k-th predetermined maximum player information for each game-progression degree with the k-th class, wherein the progressional k-th predetermined maximum player information includes information on each maximum possible number of the k-th players belonging to the k-th player group that simultaneously exist for each game-progression degree in the second state of the battle royale game, and wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, thereby setting progressional 1-st predetermined maximum player information to progressional n-th predetermined maximum player information corresponding to the 1-st class to the n-th class have been performed, the processor acquiring a game participation request for the battle royale game from a specific user device, (II) on condition that the processor has acquired at least part of 1-st standby player information to n-th standby player information in real-time, including k-th standby player information which includes a cardinal number of the k-th players belonging to the k-th player group in the first state, or at least part of 1-st surviving player information to n-th surviving player information in real-time, including k-th surviving player information which includes a cardinal number of k-th surviving players among the k-th players belonging to the k-th player group in the second state, the processor performing one of a 1-st process and a 2-nd process, wherein the 1-st process performs processes of: (i-1) determining initial selectable classes by referring to at least part of the initial 1-st predetermined maximum player information to the initial n-th predetermined maximum player information and the 1-st standby player information to the n-th standby player information in the first state, wherein the initial selectable classes are at least part of classes other than initial saturated classes among the 1-st class to the n-th class, and wherein a j-th class is determined as one of the initial saturated classes when a cardinal number of players of j-th standby player information reaches initial j-th predetermined maximum player information, (i-2) instructing the specific user device to perform one of (i-2-1) a (1_1)-st process of selecting a specific initial selectable class among the initial selectable classes and (i-2-2) a (1_2)-nd process of selecting the specific initial selectable class by using a predetermined first function with the initial selectable classes and their corresponding initial selectable probabilities as arguments, and (i-3) applying the specific initial selectable class to a specific player corresponding to the specific user device, and wherein the 2-nd process performs processes of: (ii-1) determining currently changeable classes by referring to at least part of the 1-st surviving player information to the n-th surviving player information and 1-st predetermined maximum player information to n-th predetermined maximum player information corresponding to a current game-progression degree calculated by the progress calculating function in real time among the progressional 1-st predetermined maximum player information to the progressional n-th predetermined maximum player information in the second state, wherein the currently changeable classes are at least part of classes other tha currently saturated classes among the 1-st class to the n-th class, and wherein a j′-th class is determined as one of the currently saturated classes when a cardinal number of players of j′-th survival player information reaches progressional j′-th predetermined maximum player information (ii-2) instructing the specific user device to perform one of (ii-2-1) a (2_1)-st process of selecting a specific currently changeable class among the currently changeable classes and (ii-2-2) a (2_2)-nd process of selecting the specific currently changeable class by using a predetermined second function with the currently changeable classes and their corresponding currently changeable probabilities as arguments, and (ii-3) changing a class of the specific player to the specific currently changeable class.

As one example, at the process of (II), the processor performs one of (i) the 1-st process of determining ml available initial selectable classes among the initial selectable classes by referring to a predetermined first algorithm in the first state, and performing one of (i-1) the (1_1)-st process of instructing the specific user device to select a specific available initial selectable class among the available initial selectable classes as the specific initial selectable class and (i-2) the (1_2)-nd process of selecting the specific available initial selectable class as the specific initial selectable class by using a predetermined third function whose arguments are the available initial selectable classes and their corresponding available initial selectable probabilities, to thereby apply the specific initial selectable class to the specific player, and (ii) the 2-nd process of determining m2 available currently changeable classes among the currently changeable classes by referring to a predetermined second algorithm in the second state, and performing one of (ii-1) the (2_1)-st process of instructing the specific user device to select a specific available currently changeable class among the available currently changeable classes as the specific currently changeable class and (ii-2) the (2_2)-nd process of selecting the specific available currently changeable class as the specific currently changeable class by using a predetermined fourth function whose arguments are the available currently changeable classes and their corresponding available currently changeable probabilities, to thereby apply the specific currently changeable class to the specific player.

As one example, at the process of (II), the processor performs one of (i) the 1-st process of (i-1) determining m1-1 available initial selectable classes among the initial selectable classes by referring to a predetermined first algorithm in the first state, (i-2) in response to detecting that a re-determination request of selectable classes is acquired from the specific user device, checking whether a re-determination condition of selectable classes is satisfied by referring to (1_1)-st specific state information of the specific player, (i-3) in response to detecting that the re-determination condition for selectable classes is satisfied, determining m1_2 available adjustable selectable classes among the initial selectable classes by referring to the predetermined first algorithm, and (i-4) performing one of (i-4-a) the (1_1)-st process of instructing the specific user device to select a specific available adjustable selectable class among the available adjustable selectable classes as the specific initial selectable class and (i-4-b) the (1_2)-nd process of selecting the specific available adjustable selectable class as the specific initial selectable class by using a fifth function whose arguments are the available adjustable initial selectable classes and their corresponding available adjustable initial selectable probabilities, to thereby apply the specific available adjustable selectable class to the specific player, and (ii) the 2-nd process of (ii-1) determining m2_1 available currently changeable classes among the currently changeable classes by referring to a predetermined second algorithm in the second state, (ii-2) in response to detecting that a re-determination request of changeable classes is acquired from the specific user device, checking whether a re-determination condition of changeable classes is satisfied by referring to (1_2)-nd specific state information of the specific player, (ii-3) in response to detecting that the re-determination condition of changeable classes is satisfied, determining m2_2 available adjustable currently changeable classes among the currently changeable classes by referring to the predetermined second algorithm, and (ii-4) performing one of (ii-4-a) the (2_1)-nd process of instructing the specific user device to select a specific available adjustable currently changeable class among the available adjustable currently changeable classes as the specific currently changeable class and (ii-4-b) the (2_2)-nd process of selecting the specific available adjustable currently changeable class as the specific currently changeable class by using a predetermined sixth function whose arguments are the available adjustable currently changeable classes and their corresponding available adjustable currently changeable probabilities, to thereby apply the specific currently changeable class to the specific player.

As one example, at the process of (II), the processor (i) in response to acquiring (1_1)-st process-related selection information corresponding to the (1_1)-st process from the specific user device, performs the (1_1)-st process and assigns a predetermined first penalty to the specific player, (ii) in response to acquiring (1_2)-nd process-related selection information corresponding to the (1_2)-nd process from the specific user device, performs the (1_2)-nd process and assigns a predetermined first reward to the specific player, (iii) in response to acquiring (2_1)-st process-related selection information corresponding to the (2_1)-st process from the specific user device, performs the (2_1)-st process and assigns a predetermined second penalty to the specific player, and (iv) in response to acquiring (2_2)-nd process-related selection information corresponding to the (2_2)-nd process from the specific user device, performs the (2_2)-nd process and assigns a predetermined second reward to the specific player.

As one example, at the process of (II), during the (1_2)-nd process, the processor (i) selects the specific initial selectable class by using the predetermined first function whose arguments are the initial selectable classes and their corresponding initial selectable probabilities, (ii) in response to acquiring a class re-selection request from the specific user device, checks whether a class re-selection condition is satisfied by referring to (2_1)-st specific state information of the specific player, and (iii) in response to satisfying the class re-selection condition, selects a predetermined initial selectable class as the specific initial selectable class by using the predetermined first function, and wherein, during the (2_2)-nd process, the processor (i) selects the specific currently changeable class by using the specific second function whose arguments are the currently changeable classes and their corresponding currently changeable probabilities, (ii) in response to acquiring a class re-change request from the specific user device, checks whether a class re-change condition is satisfied by referring to (2_2)-nd specific state information of the specific player, and (iii) in response to satisfying the class re-change condition, selects a predetermined currently changeable class as the specific currently changeable class by using the predetermined second function.

As one example, at the process of (I), on condition that the processor has additionally performed at least one of processes of (i) setting a 1-st class perk to an n-th class perk corresponding to the 1-st class to the n-th class by matching a k-th class perk with the k-th class, wherein the k-th class perk is a special ability applied to the k-th players belonging to the k-th player group, (ii) setting a 1-st class ultimate skill to an n-th class ultimate skill corresponding to the 1-st class to the n-th class by matching a k-th class ultimate skill with the k-th class, and (iii) setting a 1-st class synergy item to an n-th class synergy item corresponding to the 1-st class to the n-th class by matching a k-th class synergy item with the k-th class, wherein the k-th class synergy item is an item that enhances any item used by the k-th players used within the battle royale game, the processor acquires the game participation request from the specific user device, and wherein, at the process of (II), during the 1-st process, the processor applies a g-th class, which is the specific initial selectable class, to the specific player to thus (i) determine at least one of (1) at least one specific g-th class perk selected by using a predetermined (7_1)-st function whose arguments are at least one g-th class perk and its corresponding g-th class perk probability corresponding to the g-th class, (2) at least one specific g-th class ultimate skill selected by using a predetermined (7_2)-nd function whose arguments are at least one g-th class ultimate skill and its corresponding g-th class ultimate skill probability corresponding to the g-th class, and (3) at least one specific g-th class synergy item selected by using a predetermined (7_3)-rd function whose arguments are at least one g-th class synergy item and its corresponding g-th class synergy item probability corresponding to the g-th class, and (ii) set at least one of the specific g-th class perk, the specific g-th class ultimate skill, and the specific g-th class synergy item to correspond to the specific player, and wherein, at the process of (II), during the 2-nd process, the processor changes the class of the specific player to an h-th class, which is the specific currently changeable class, to thus (i) determine at least one of (1) at least one specific h-th class perk selected by using a predetermined (8_1)-st function whose arguments are at least one h-th class perk and its corresponding h-th class perk probability corresponding to the h-th class, (2) at least one specific h-th class ultimate skill selected by using a predetermined (8_2)-nd function whose arguments are at least one h-th class ultimate skill and its corresponding h-th class ultimate skill probability corresponding to the h-th class, and (3) at least one specific h-th class synergy item selected by using a predetermined (8_3)-rd function whose arguments are at least one h-th class synergy item and its corresponding h-th class synergy item probability corresponding to the h-th class, and (ii) change at least one of current class perk, current ultimate skill, and current class synergy item of the specific player to at least one of the specific h-th class perk, the specific h-th class ultimate skill, and the specific h-th class synergy item.

As one example, at the process of (I), on condition that the processor has additionally performed at least one of processes of (i) setting a 1-st class perk to an n-th class perk respectively corresponding to the 1-st class to the n-th class by matching at least one k-th class perk with the k-th class, wherein the k-th class perk is a special ability applied to the k-th players belonging to the k-th player group, (ii) setting a 1-st class ultimate skill to an n-th class ultimate skill respectively corresponding to the 1-st class to the n-th class by matching a k-th class ultimate skill with the k-th class, and (iii) setting a 1-st class synergy item to an n-th class synergy item respectively corresponding to the 1-st class to the n-th class by matching a k-th class synergy item with the k-th class, wherein the k-th class synergy item is an item that enhances any item used by the k-th players used within the battle royale game, the processor acquires the game participation request from the specific user device, and wherein, at the process of (II), during the (1_1)-st process, the processor provides information on (i) an initial selectable class perk, among the 1-st class perk to the n-th class perk, corresponding to the initial selectable class, (ii) an initial selectable class ultimate skill, among the 1-st class ultimate skill to the n-th class ultimate skill, corresponding to the initial selectable class, and (iii) an initial selectable class synergy item, among the 1-st class synergy item to the n-th class synergy item, corresponding to the initial selectable class, to the specific user device, to thereby instruct the specific user device to select the specific initial selectable class by referring to at least part of the information on the initial selectable class perk, the initial selectable class ultimate skill, and the initial selectable class synergy item, and wherein, at the process of (II), during the (2_1)-st process, the processor provides information on (i) a currently changeable class perk, among the 1-st class perk to the n-th class perk, corresponding to the currently changeable class, (ii) a currently changeable class ultimate skill, among the 1-st class ultimate skill to the n-th class ultimate skill, corresponding to the currently changeable class, and (iii) a currently changeable class synergy item, among the 1-st class synergy item to the n-th class synergy item, corresponding to the currently changeable class, to the specific user device, to thereby instruct the specific user device to select the specific currently changeable class by referring to at least part of the information on the currently changeable class perk, the currently changeable class ultimate skill, and the currently changeable class synergy item.

As one example, at the process of (II), during the (1_1)-st process, in response to receiving a request for standby player information from the specific user device, the processor provides at least part of the 1-st standby player information to the n-th standby player information to the specific user device, to thereby instruct the specific user device to select the specific initial selectable class by referring to at least part of the 1-st standby player information to the n-th standby player information, and wherein, at the process of (II), during the (2_1)-st process, in response to receiving a request for surviving player information from the specific user device, the processor provides at least part of the 1-st surviving player information to the n-th surviving player information to the specific user device, to thereby instruct the specific user device to select the specific currently changeable class by referring to at least part of the 1-st surviving player information to the n-th surviving player information.

As one example, at the process of (I), on condition that the processor has performed processes of matching at least part of progressional k-th available item information and progressional k-th item performance information for each game-progression degree with the k-th class, wherein the progressional k-th available item information includes usable items of the k-th players for each game-progression degree and the progressional k-th item performance information includes performance information of the usable items of the k-th players for each game-progression degree, to thereby set at least part of progressional 1-st available item information to progrsesional n-th available item information and progressional 1-st item performance information to progressional n-th item performance information, the processor acquires the game participation request from the specific user device, and wherein the processor further performs a process of: (III) changing at least part of an item type and an item performance of the usable item within the battle royale game by referring to at least part of 1-st available item information to n-th available item information and 1-st item performance information to n-th item performance information corresponding to the current game-progression degree among the progressional 1-st available item information to the progressional n-th available item information and the progrsesional 1-st item performance information to the progrssional n-th item performance information.

As one example, at the process of (I), on condition that the processor has additionally performed a process of setting at least part of progressional 1-st class perk information to progressional n-th class perk information, progressional 1-st class ultimate skill information to progressional n-th class ultimate skill information, and progrsesional 1-st class synergy item information to progressional n-th class synergy item information by matching at least part of each progressional k-th class perk information, each progressional k-th ultimate skill information, and each progrssional k-th class synergy item information with the k-th class, wherein the progressional k-th class perk information includes at least one k-th class perk applied to the k-th players for each game-progression degree in the second state, the progressional k-th class ultimate skill information includes at least one k-th class ultimate skill applied to the k-th players for each game-progression degree in the second state, and the progressional k-th class synergy item information includes at least one k-th class synergy item applied to the k-th players for each game-progression degree in the second state, the processor acquires the game participation request from the specific user device, and wherein the processor further performs a process of: (IV) changing at least part of the 1-st class perk to the n-th class perk, the 1-st class ultimate skill to the n-th class ultimate skill, and the 1-st class synergy item to the n-th class synergy item within the battle royale game by referring to at least part of 1-st class perk information to n-th class perk information, 1-st class ultimate skill information to n-th class ultimate skill information, and 1-st class synergy item information to n-th class synergy item information corresponding to the current game-progression degree respectively among the progressional 1-st class perk information to the progressional n-th class perk information, the progressional 1-st class ultimate skill information to the progressoinal n-th class ultimate skill information, and the progressional 1-st class synergy item information to the progressoinal n-th class synergy item information.

### BRIEF DESCRIPTION OF THE DRAWINGS

The following drawings to be used for explaining example embodiments of the present disclosure are only part of example embodiments of the present disclosure and other drawings can be obtained based on the drawings by those skilled in the art of the present disclosure without inventive work.

FIG. 1 is a drawing schematically illustrates a server that provides a battle royale game based on a plurality of classes in accordance with one example embodiment of the present disclosure.

FIG. 2 is a drawing schematically illustrates processes of providing the battle royale game based on the plurality of classes in accordance with one example embodiment of the present disclosure.

FIGS. 3A and 3B are drawings schematically illustrating a process of allowing a specific class to be selected among the plurality of classes in accordance with one example embodiment of the present disclosure.

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to those skilled in the art, partially from the specification and partially from the implementation of the present disclosure. The following examples and drawings will be provided as examples but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to the present disclosure to be carried out easily, the example embodiments of the present disclosure by referring to attached diagrams will be explained in detail as shown below.

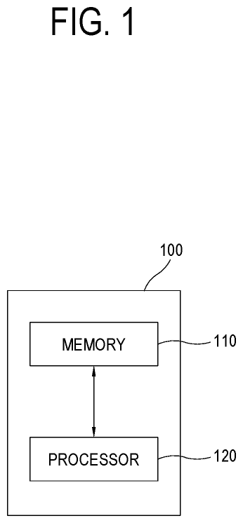

FIG. 1 is a drawing schematically illustrating a server 100 in accordance with one example embodiment of the present disclosure. Referring to FIG. 1, the server 100 may include a memory 110 for storing instructions to provide a battle royale game based on a plurality of classes and a processor 120 for performing processes of providing the battle royale game based on the plurality of classes according to the instructions stored in the memory 110 in accordance with one example embodiment of the present disclosure.

Specifically, the server 100 may typically achieve a desired system performance by using combinations of at least one computing device such as a computer processor, a memory, a storage, an input device, an output device, or any other conventional computing components, at least one electronic communication device such as a router or a switch, at least one electronic information storage system such as a network-attached storage (NAS) device or a storage area network (SAN), and at least one computer software, i.e., any instructions that allow the computing device to function in a specific manner.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

A method for providing the battle royale game based on the plurality of classes using the server 100 configured as such is described as follows by referring to Figures.

As used in this specification and the appended claims, the singular forms “a,” “an,” and “the” include plural referents, i.e., one or more, unless the content and context clearly dictates otherwise.

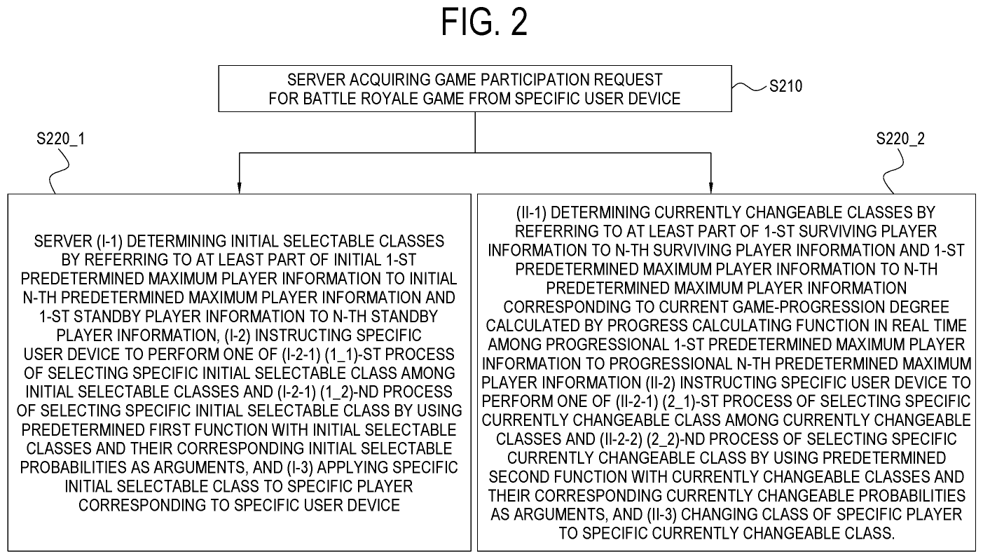

FIG. 2 schematically illustrates processes for providing the battle royale game based on the plurality of classes in accordance with one example embodiment of the present disclosure. Referring to FIG. 2, the server 100 may acquire a game participation request for the battle royale game from a specific user device, at a step of S210, to thereby (1) (i-1) determine initial selectable classes by referring to at least part of initial 1-st predetermined maximum player information to initial n-th predetermined maximum player information and 1-st standby player information to n-th standby player information, (i-2) instruct the specific user device to perform one of (i-2-1) a (1_1)-st process of selecting a specific initial selectable class among the initial selectable classes and (i-2-2) a (1_2)-nd process of selecting the specific initial selectable class by using a predetermined first function with the initial selectable classes and their corresponding initial selectable probabilities as arguments, and (i-3) apply the specific initial selectable class to a specific player, at a step of S220 1 (i.e., a so-called 1-st process), and (2) (ii-1) determine currently changeable classes by referring to at least part of the 1-st surviving player information to the n-th surviving player information and 1-st predetermined maximum player information to n-th predetermined maximum player information corresponding to a current game-progression degree calculated by the progress calculating function in real time among progressional 1-st predetermined maximum player information to progressional n-th predetermined maximum player information, (ii-2) instruct the specific user device to perform one of (ii-2-1) a (2_1)-st process of selecting a specific currently changeable class among the currently changeable classes and (ii-2-2) a (2_2)-nd process of selecting the specific currently changeable class by using a predetermined second function with the currently changeable classes and their corresponding currently changeable probabilities as arguments, and (ii-3) change a class of the specific player to the specific currently changeable class, at a step of 5220 2 (i.e., a so-called 2-nd process). Herein, the “progressional 1-st predetermined maximum player information” represents multiple pieces of 1-st predetermined maximum player information corresponding to respective game-progression degrees and the “progressional n-th predetermined maximum player information” represents multiple pieces of n-th predetermined maximum player information corresponding to the respective game-progression degrees.

The processes of the server 100 providing the battle royale game based on the plurality of classes in accordance with one example embodiment of the present disclosure has been described above, and more details thereof will be described below.

First, as described above, at least one of a 1-st pre-process and a 2-nd pre-process may have been performed.

For example, as the 1-st pre-process, a process of matching initial k-th predetermined maximum player information with a k-th class, while varying k from 1 to n, may have been performed to set the initial 1-st predetermined maximum player information to the initial n-th predetermined maximum player information for each of a 1-st class to an n-th class. Herein, the initial k-th predetermined maximum player information corresponds to a k-th player group, to which the k-th class is applied, among a plurality of player groups participating in the battle royale game.

Herein, (i) a first state of the battle royale game represents a standby state in which at least part of each player belonging to each player group with at least the 1-st class to the n-th class applied thereto log into the battle royale game and wait in a same waiting space, and (ii) a second state represents a state after the first state, where the battle royale game has started and each player play the battle royale game. Herein the initial k-th predetermined maximum player information may include information on a maximum possible number of k-th players belonging to the k-th player group that exist simultaneously in the first state of the battle royale game. Herein, k is an integer greater than or equal to 1 and less than or equal to n.

Further, the 1-st class to the n-th class may be jobs assigned to the players. For instance, the 1-st class to the n-th class may include jobs such as gatlings, gas soldiers, teleporters, nuclear specialists, snipers, marines, drivers, mobile strike teams, SWAT, gun specialists, shotgun masters, reconnaissance teams, etc. Furthermore, at least part of each of unique special abilities, each of unique special items (that is, class synergy items), and each of ultimate skills may be set for each of the 1-st class to the n-th class.

Moreover, as the 2-nd pre-process, a process of matching each progressional k-th predetermined maximum player information for each game-progression degree with the k-th class may have been performed to set the progressional 1-st predetermined maximum player information to the progressional n-th predetermined maximum player information corresponding to the 1-st class to the n-th class.

Herein, the progressional k-th predetermined maximum player information may include information on each maximum possible number of the k-th players belonging to the k-th player group that simultaneously exist for each game-progression degree in the second state of the battle royale game.

Further, the game-progression degree may be calculated by using a progress calculating function whose arguments include at least part of (i) elapsed time information which represents a time elapsed after the battle royale game enters the second state, (ii) player battle power information which represents a battle powers of at least part of a plurality of players, (iii) a cardinal number of surviving players among the plurality of players, (iv) area phase information which represents a state of a safe area and a dangerous area being changed according to area metadata, and (v) possessed items of the surviving players.

For example, if two minutes have elapsed since entering into the second state and the area phase information of the safe area and the dangerous area is at a first phase, the game-progression degree calculated by using the progress calculating function with arguments including at least part of the “two minutes” as the elapsed time information and the “first phase” as the area phase information may satisfy a triggering point that is needed for entering into the first stage. Herein, the word “stage” is used to conveniently represent information on the number of times at which the game-progression degree is changed.

As another example, if 22 minutes have elapsed since entering into the second state and the area phase information of the safe area and the dangerous area is at a fifth phase, the game-progression degree calculated by using the progress calculating function with arguments including at least part of the “22 minutes” as the elapsed time information and the “fifth phase” as the area phase information may satisfy the triggering point that is needed for entering into a ninth stage.

Additionally, the progressional k-th predetermined maximum player information set for each game-progression degree is explained. For example, 10 may be set as the progressional k-th predetermined maximum player information corresponding to a predetermined time section, but it may also be set in real-time. Herein, the predetermined time section is after a time point of satisfying the triggering point that is needed for entering the first stage.

As another example, it is possible to predict the time point of satisfying the triggering point that is needed for entering the first stage in advance. In this case, the progressional k-th predetermined maximum player information corresponding to the predetermined time section (which is after a predicted time point of satisfying the triggering point that is needed for entering the first stage) may be set as 10 or may be set in real-time.

As still another example, “3” may be set as the progressional k-th predetermined maximum player information corresponding to the predetermined time section (which is after a predicted time point of satisfying the triggering point that is needed for entering the ninth stage) or the progressional k-th predetermined maximum player information may be set in real-time.

As still yet another example, “3” may be set as the progressional k-th predetermined maximum player information corresponding to the predetermined time section (which is after a predicted time point of satisfying the triggering point that is needed for entering the ninth stage) or the progressional k-th predetermined maximum player information may be set in real-time.

For reference, the server 100 may determine whether the current game-progression degree calculated by the progress calculating function in real time at the second stage satisfies a predetermined condition.

For example, the server 100 may determine whether the triggering point is satisfied by referring to at least part of the elapsed time information, the player battle power information, the area phase information, the cardinal number of surviving players, and the possessed item of the surviving players corresponding to the current game-progression degree or a combination thereof.

For instance, on condition that “1000”, “first phase”, and “80” have been set for triggering points of (i) average player battle power information, (ii) the area phase information, and (iii) the cardinal number of surviving players respectively, in case the average battle power information, the area phase information, and the cardinal number of surviving players (respectively corresponding to a specific game-progression degree acquired by the progress calculating function in real time) are determined as “1200”, “first phase”, and “75” , the server 100 may determine that the current game-progression degree is satisfying the predetermined condition. It is appreciated that not all the triggering factors mentioned above should be satisfied.

That is, as another example, on condition that “2000” has been set for a triggering point corresponding to a combination of the average player battle power information, the area phase information, and the cardinal number of surviving players, in case a point (that is, a function value) of the combination of the average player battle power information, the area phase information, and the cardinal number of surviving players acquired by using the progress calculating function in real time is determined as “2500”, the server 100 may determine that the predetermined condition is satisfied.

As still another example, on condition that “1500, “second phase”, and “50” have been set for the triggering points of average player battle power information, the area phase information, and the cardinal number of surviving players respectively, in case the average battle power information, the area phase information, and the cardinal number of surviving players (respectively corresponding to the specific game-progression degree acquired by using the progress calculating function in real time) are determined as “1450”, “first phase”, and “55”, even though the triggering points are not met yet, because the triggering points will be satisfied within a short period, the server 100 may predict a timing of satisfying the triggering points with reference to the amount of change and the change rate for each of the triggering factors.

As such, on condition that at least one of processes of (i) setting the initial 1-st predetermined maximum player information to the initial n-th predetermined maximum player information corresponding to the 1-st class to the n-th class, and (ii) setting the progressional 1-st predetermined maximum player information to the progressional n-th predetermined maximum player information corresponding to the 1-st class to the n-th class have been performed, the server 100 may acquire the game participation request for the battle royale game from the specific user device.

Further, the server 100 may perform one of (i) a 1-st process of applying the specific initial selectable class to the specific player and (ii) a 2-nd process of changing the class of the specific player to the specific currently changeable class, and details of which will be explained in detail below.

First, to exemplarily describe the 1-st process, on condition that the server 100 has acquired at least part of the 1-st standby player information to the n-th standby player information in real time, including k-th standby player information, the server 100, in the first state, may refer to at least part of the initial 1-st predetermined maximum player information to the initial n-th predetermined maximum player information and the 1-st standby player information to the n-th standby player information, to thereby determine the initial selectable classes.

For reference, the k-th standby player information may include a cardinal number of the k-th players belonging to the k-th player group in the first state, and the initial selectable classes may be at least part of the 1-st class to the n-th class other than initial saturated classes. Herein, the initial saturated classes may be a j-th class in case a cardinal number of players corresponding to j-th standby player information reaches initial j-th predetermined maximum player information. Herein, j is an integer greater than or equal to 1 and less than or equal to n.

For example, if initial 5-th predetermined maximum player information and 5-th standby player information corresponding to a 5-th class, among the 1-st class to a 10-th class, are 5 and 5 respectively, then the 5-th class is determined as one of the initial saturated classes. In such a case, the server 100 may select remaining classes other than the 5-th class (that is, the 1-st class to a 4-th class and a 6-th class to the 10-th class) as the initial selectable classes among the 1-st class to the 10-th class.

Also, the server 100 may (i) instruct the specific user device to perform one of (i-1) the (1_1)-st process of selecting the specific initial selectable class among the initial selectable classes and (i-2) the (1_2)-nd process of selecting the specific initial selectable class by using the predetermined first function with the initial selectable classes and their corresponding initial selectable probabilities as arguments, to thereby perform the 1-st process of applying the specific initial selectable class to the specific player corresponding to the specific user device.

As an example, during the (1_2)-nd process, if the initial selectable classes among the entire classes, e.g., the 1-st class to an 8-th class, are the 1-st class to the 4-th class and their corresponding initial selectable probabilities are (0.2, 0.3, 0.4, 0.1), the server 100 may use the predetermined first function with the initial selectable classes and their corresponding initial selectable probabilities as arguments, to thereby select a 3-rd class with the highest probability to be the specific initial selectable class. It is to be appreciated that, unlike above, the server 100 may select the 4-th class, which has the lowest probability of 0.1, as the specific initial selectable class.

As another example, during the (1_2)-nd process, if the initial selectable classes among the entire classes, e.g., the 1-st class to an 8-th class, are the 1-st class to the 4-th class and their corresponding initial selectable probabilities are (0, 1, 0, 0), the server 100 may use the predetermined first function with the initial selectable classes and their corresponding initial selectable probabilities as arguments, to thereby select a 2-nd class to be the specific initial selectable class. It is to be appreciated that it is possible to set all probability values to be non-zeros.

Second, to exemplarily describe the 2-nd process, on condition that the server 100 has acquired at least part of the 1-st surviving player information to the n-th surviving player information (including k-th surviving player information) in real time, the server 100, in the second state, may select the currently changeable classes by referring to at least part of the 1-st surviving player information to the n-th surviving player information and 1-st predetermined maximum player information to n-th predetermined maximum player information corresponding to the current game-progression degree calculated by the progress calculating function in real time, among the progressional 1-st predetermined maximum player information to the progressional n-th predetermined maximum player information.

For reference, the k-th surviving player information may include a cardinal number of the k-th surviving players belonging to the k-th player group in the second state, and the currently changeable classes may be at least part of the 1-st class to the n-th class other tha currently saturated classes.

Also, the currently saturated classes may include a j′-th class in case a cardinal number of players of j′-th predetermined maximum player information corresponding to the current game-progression degree and a cardinal number of players of j′-th surviving player information are the same, or in case the cardinal number of players of j′-th predetermined maximum player information is less than the cardinal number of players of j′-th suriving player information.

For example, if 3-rd predetermined maximum player information and 3-rd surviving player information corresponding to the current game-progression degree for a 3-rd class (among the 1-st class to a 7-th class) are 4 and 4 respectively, then the 3-rd class is determined as one of the currently saturated classes. For such a case, the server 100 may select remaining classes other than the 3-rd class (that is, the 1-st class to the 2-nd class and the 4-th class to the 7-th class) as the currently changeable classes among the 1-st class to the 7-th class.

As another example, if 2-nd predetermined maximum player information and 2-nd surviving player information corresponding to the current game-progression degree for the 2-nd class (among the 1-st class to the 7-th class) are 5 and 7 respectively, then the 2-nd class is determined as one of the currently saturated classes. For such a case, the server 100 may select remaining classes other than the 2-nd class (that is, the 1-st class and the 3-rd class to the 7-th class) as the currently changeable classes among the 1-st class to the 7-th class.

Also, the server 100 may (i) instruct the specific user device to perform one of (i-1) the (2_1)-st process of selecting the specific currently changeable class among the currently changeable classes and (i-2) the (2_2)-nd process of selecting the specific currently changeable class by using the predetermined second function with the currently changeable classes and their corresponding currently changeable probabilities as arguments, to thereby perform the 2-nd process of changing the class of the specific player to the specific currently changeable class.

As an example, during the (2_2)-nd process, if the currently changeable classes among the entire classes, e.g., the 1-st class to the 6-th class, are the 1-st class to the 5-th class and their corresponding currently changeable probabilities are (0.2, 0.4, 0.2, 0.15, 0.05), the server 100 may select the 2-nd class with the highest probability to be the specific currently changeable class by using the predetermined second function with the currently changeable classes and their corresponding currently changeable probabilities as arguments. It is to be appreciated that, unlike above, the server 100 may select the 5-th class, which has the lowest probability of 0.05, as the specific currently changeable class.

As an example, during the (2_2)-nd process, if the currently changeable classes among the entire classes, e.g., the 1-st class to the 6-th class, are the 1-st class to the 5-th class and their corresponding currently changeable probabilities are (0, 0, 1, 0, 0), the server 100 may select the 3-rd class to be the specific currently changeable class by using the predetermined second function with the currently changeable classes and their corresponding currently changeable probabilities as arguments. It is appreciated that all probability values may be set to be non-zeros.

Processes of selecting the specific initial selectable class for the specific player and changing the class of the specific player to the specific currently changeable class have been explained above. Below, various examples of how the server 100 provides the battle royale game based on the plurality of classes will be explained.

For example, the server 100 may determine some of the initial selectable classes as selectable class candidates and select a specific class among the selectable class candidates to thereby apply the specific class to the specific player.

For example, in the first state, the server 100 may determine ml available initial selectable classes among the initial selectable classes by referring to a first algorithm. For reference, ml may be less than or equal to the number of the initial selectable classes.

Also, the server 100 may perform one of (i) the (1_1)-st process of instructing the specific user device to select a specific available initial selectable class among the available initial selectable classes as the specific initial selectable class and (ii) the (1_2)-nd process of selecting the specific available initial selectable class as the specific initial selectable class by using a predetermined third function whose arguments are the available initial selectable classes and their corresponding available initial selectable probabilities, to thereby apply the specific initial selectable class to the specific player.

As another example, the server 100 may determine some of the currently changeable classes as changeable class candidates and change the class of the specific player to the specific class selected among the changeable class candidates.

For example, in the second state, the server 100 may determine m2 available currently changeable classes among the currently changeable classes by referring to a second algorithm. For reference, m2 may be less than or equal to the number of the currently changeable classes.

Further, the server 100 may perform one of (i) the (2_1)-st process of instructing the specific user device to select a specific available currently changeable class among the available currently changeable classes as the specific currently changeable class and (ii) the (2_2)-nd process of selecting the specific available currently changeable class as the specific currently changeable class by using a predetermined fourth function whose arguments are the available currently changeable classes and their corresponding available currently changeable probabilities, to thereby change the current class of the specific player to the specific currently changeable class.

Meanwhile, since there may not be a class which is desired by the specific player among the selectable/changeable class candidates (for example, the available initial selectable classes or the available currently changeable classes), the server 100 may provide another chance to the plurality of players to re-determine another one of the selectable/changeable class candidates.

For example, the server 100 may (i) determine m1-1 available initial selectable classes among the initial selectable classes by referring to a predetermined first algorithm in the first state, and (ii) in response to detecting a re-determination request of selectable classes acquired from the specific user device, check whether a re-determination condition of selectable classes is satisfied by referring to (1_1)-st specific state information of the specific player. For reference, m1_1 may be less than or equal to the number of the initial selectable classes.

Additionally, the (1_1)-st specific state information of the specific player may include information on goods possessed by the specific player, rank of the specific player, a cardinal number of remaining chances of the specific player being able to perform the re-determination request.

Also, in response to detecting that the re-determination condition for selectable classes is satisfied, the server 100 may determine m1_2 available adjustable selectable classes by referring to the predetermined first algorithm. For reference, m1_2 may be less than or equal to the number of the initial selectable classes.

Also, the server 100 may perform one of (i) the (1_1)-st process of instructing the specific user device to select a specific available adjustable selectable class among m1_2 available adjustable selectable classes as the specific initial selectable class and (ii) the (1_2)-nd process of selecting the specific available adjustable selectable class as the specific initial selectable class by using a fifth function whose arguments are the available adjustable initial selectable classes and their corresponding available adjustable initial selectable probabilities, to thereby apply the specific available adjustable selectable class to the specific player.

As another example, the server 100 may (i) determine m2_1 available currently changeable classes among the currently changeable classes by referring to a predetermined second algorithm in the second state, and in response to detecting a re-determination request of changeable classes acquired from the specific user device, check whether a re-determination condition of changeable classes is satisfied by referring to (1_2)-nd specific state information of the specific player. For reference, m2_1 may be less than or equal to the number of the currently changeable classes.

For reference, since descriptions of the (1_2)-nd specific state information are similar to descriptions of the (1_1)-st specific state information, further description will be omitted.

Additionally, in response to detecting that the re-determination condition for changeable classes is satisfied, the server 100 may determine m2_2 available adjustable currently changeable classes by referring to the predetermined second algorithm. For reference, m2_2 may be less than or equal to the number of the currently changeable classes.

Further, the server 100 may perform one of (i) the (2_1)-st process of instructing the specific user device to select a specific available adjustable currently changeable class among available adjustable currently changeable classes as the specific currently changeable class and (ii) the (2_2)-nd process of selecting the specific available adjustable currently changeable class as the specific currently changeable class by using a predetermined sixth function whose arguments are the available adjustable currently changeable classes and their corresponding available adjustable currently changeable probabilities, to thereby apply the current class of the specific player to the specific currently changeable class.

Meanwhile, the server 100 may award a predetermined penalty/reward to the specific player depending on whether the class of the specific player was selected/changed by the specific user device or selected/changed by the server 100.

For example, (i) in response to acquiring (1_1)-st process-related selection information corresponding to the (1_1)-st process (that is, if the specific user device selects the class of the specific player) from the specific user device, the server 100 may perform the (1_1)-st process and assign a predetermined first penalty to the specific player, (ii) in response to acquiring (1_2)-nd process-related selection information corresponding to the (1_2)-nd process (that is, if the server 100 selects the class of the specific player) from the specific user device, the server 100 may perform the (1_2)-nd process and assign a predetermined first reward to the specific player, (iii) in response to acquiring (2_1)-st process-related selection information corresponding to the (2_1)-st process (that is, if the specific user device changes the class of the specific player) from the specific user device, the server 100 may perform the (2_1)-st process and assign a predetermined second penalty to the specific player, and (iv) in response to acquiring (2_2)-nd process-related selection information corresponding to the (2_2)-nd process (that is, if the server changes the class of the specific player) from the specific user device, the server 100 may perform the (2_2)-nd process and assign a predetermined second reward to the specific player.

As an example, the predetermined first penalty and/or the predetermined second penalty may be imposed by deducting the specific player's goods, but it is not limited thereto.

In addition, the predetermined first reward and/or the predetermined second reward may be (i) a reward directly provided to the specific player, for instance, predetermined goods that can be used within the battle royale game, but they are not limited thereto, or (ii) a reward indirectly provided to the specific player, for instance, not applying the predetermined first penalty or the predetermined second penalty to the specific player, etc.

Meanwhile, according the processes above, there may be times when classes selected by the server 100 may not include a class desired by the specific player, therefore, the server 100 may provide another chance to the specific player to re-select the class.

For example, during the (1_2)-nd process, the server 100 may (i) select the specific initial selectable class by using the predetermined first function whose arguments are the initial selectable classes and their corresponding initial selectable probabilities, and (ii) in response to acquiring a class re-selection request from the specific user device, check whether the class re-selection condition is satisfied by referring to (2_1)-st specific state information of the specific player.

For reference, since descriptions of the (2_1)-st specific state information and (2_2)-nd specific state information are similar to descriptions of the (1_1)-st specific state information and the (1_2)-nd specific state information, further descriptions thereof will be omitted.

Also, in response to detecting that the class re-selection condition is satisfied, the server 100 may select a predetermined initial selectable class as the specific initial selectable class by referring to the predetermined first function .

As another example, during the (2_2)-nd process, the server 100 may (i) select the specific currently changeable class by using the specific second function whose arguments are the currently changeable classes and their corresponding currently changeable probabilities, and (ii) in response to acquiring a class re-change request from the specific user device, check whether a class re-change condition is satisfied by referring to (2_2)-nd specific state information of the specific player.

Further, in response to satisfying the class re-change condition, the server 100 may select a predetermined currently changeable class as the specific currently changeable class by using the predetermined second function.

Meanwhile, the server 100 may support the specific player to select an optimal class by providing standby player information and/or surviving player information to the specific user device.

For example, during the (1_1)-st process, in response to receiving a request for standby player information from the specific user device, the server 100 may provide at least part of the 1-st standby player information to the n-th standby player information to the specific user device, to thereby instruct the specific user device to select the specific initial selectable class by referring to at least part of the 1-st standby player information to the n-th standby player information.

As another example, during the (2_1)-st process, in response to receiving a request for surviving player information from the specific user device, the server 100 may provide at least part of the 1-st surviving player information to the n-th surviving player information to the specific user device, to thereby instruct the specific user device to select the specific currently changeable class by referring to at least part of the 1-st surviving player information to the n-th surviving player information.

As mentioned before, at least part of each special ability, each specialized item (e.g., class synergy item), each ultimate skill, and each physical ability can be set for each class, and thus the specific player may utilize at least part thereof to survive in the battle royale game.

For example, processes such as (i) setting a 1-st class perk to an n-th class perk corresponding to the 1-st class to the n-th class by matching a k-th class perk with the k-th class (while varying k from 1 to n), (ii) setting a 1-st class ultimate skill to an n-th class ultimate skill corresponding to the 1-st class to the n-th class by matching a k-th class ultimate skill with the k-th class (while varying k from 1 to n), and (iii) setting a 1-st class synergy item to an n-th class synergy item corresponding to the 1-st class to the n-th class by matching a k-th class synergy item with the k-th class (while varying k from 1 to n), may be performed.

For reference, the k-th class perk may be the special ability applied to the k-th players belonging to the k-th player group, and the k-th class synergy item is an item that enhances any item used by the k-th players within the battle royale game.

Further, on condition that at least part of a class perk, a class ultimate skill, and a class synergy item have been set per class, the server 100 may acquire a game participation request from the specific user device.

Furthermore, during the 1-st process, the server 100 may apply a g-th class, which is the specific initial selectable class, to the specific player to thus (i) determine at least one of (i-1) at least one specific g-th class perk selected by using a predetermined (7_1)-st function whose arguments are at least one g-th class perk and its corresponding g-th class perk probability corresponding to the g-th class, (i-2) at least one specific g-th class ultimate skill selected by using a predetermined (7_2)-nd function whose arguments are at least one g-th class ultimate skill and its corresponding g-th class ultimate skill probability corresponding to the g-th class, and (i-3) at least one specific g-th class synergy item selected by using a predetermined (7_3)-rd function whose arguments are at least one g-th class synergy item and its corresponding g-th class synergy item probability corresponding to the g-th class, and (ii) set at least one of the specific g-th class perk, the specific g-th class ultimate skill, and the specific g-th class synergy item to correspond to the specific player.

Additionally, during the 2-nd process, the server 100 may change the class of the specific player to an h-th class, which is the specific currently changeable class, to thus (i) determine at least one of (i-1) at least one specific h-th class perk selected by using a predetermined (8_1)-st function whose arguments are at least one h-th class perk and its corresponding h-th class perk probability corresponding to the h-th class, (i-2) at least one specific h-th class ultimate skill selected by using a predetermined (8_2)-nd function whose arguments are at least one h-th class ultimate skill and its corresponding h-th class ultimate skill probability corresponding to the h-th class, and (i-3) at least one specific h-th class synergy item selected by using a predetermined (8_3)-rd function whose arguments are at least one h-th class synergy item and its corresponding h-th class synergy item probability corresponding to the h-th class, and (ii) change at least one of current class perk, current ultimate skill, and current class synergy item of the specific player to at least one of the specific h-th class perk, the specific h-th class ultimate skill, and the specific h-th class synergy item.

Herein, the server 100 may support the specific player to select the optimal class by providing information on at least part of the class perk, the ultimate skill, and the synergy item to the specific user device.

For example, during the (1_1)-st process, the server 100 may provide information on (i) an initial selectable class perk, among the 1-st class perk to the n-th class perk, corresponding to the initial selectable class, (ii) an initial selectable class ultimate skill, among the 1-st class ultimate skill to the n-th class ultimate skill, corresponding to the initial selectable class, and (iii) an initial selectable class synergy item, among the 1-st class synergy item to the n-th class synergy item, corresponding to the initial selectable class, to the specific user device, to thereby instruct the specific user device to select the specific initial selectable class by referring to at least part of the information on the initial selectable class perk, the initial selectable class ultimate skill, and the initial selectable class synergy item.

As another example, during the (2_1)-st process, the server 100 may provide information on (i) a currently changeable class perk, among the 1-st class perk to the n-th class perk, corresponding to the currently changeable class, (ii) a currently changeable class ultimate skill, among the 1-st class ultimate skill to the n-th class ultimate skill, corresponding to the currently changeable class, and (iii) a currently changeable class synergy item, among the 1-st class synergy item to the n-th class synergy item, corresponding to the currently changeable class, to the specific user device, to thereby instruct the specific user device to select the specific currently changeable class by referring to at least part of the information on the currently changeable class perk, the currently changeable class ultimate skill, and the currently changeable class synergy item.

It is noted that strategies/tactics of a conventional battle royale game are fixed, for example, in a limited map with a predetermined number of players, there are frequent cases of only using 2-3 types of specific weapons known to provide good performance among dozens of weapons provided in the battle royale game.

As such, there is a problem of the users of the battle royale game losing interest because of simplified game strategies due to repeated use of the specific weapons, thus resulting in a decrease replayability of the battle royale game.

Therefore, in order to overcome the above problem, the server 100 may allow the plurality of players to change at least part of an item type and an item performance by referring to the game-progression degree, thereby sustaining interests of the players.

For example, on condition that the server 100 has performed processes of matching at least part of progressional k-th available item information and progressional k-th item performance information for each game-progression degree with the k-th class (while varying k from 1 to n), to thereby set at least part of progressional 1-st available item information to progressional n-th available item information and progressional 1-st item performance information to progressional n-th item performance information, the server 100 may acquire the game participation request from the specific user device.

For reference, the progressional k-th available item information may include usable items of the k-th players for each game-progression degree and the progressional k-th item performance information may include performance of the items used by the k-th players for each game-progression degree.

Further, the server 100 may change at least part of the item type and the item performance of the item within the battle royale game by referring to at least part of 1-st available item information to n-th available item information and 1-st item performance information to n-th item performance information (corresponding to the current game-progression degree) among the progressional 1-st available item information to the progressional n-th available item information and the progressional 1-st item performance information to the professional n-th item performance information.

In addition, the server 100 may change the class perk, the class ultimate skill, and the class synergy item according to the current game-progression degree of the battle royale game, similarly to changing at least part of the item type and the item performance as described above.

For example, on condition that the server 100 has performed processes of setting at least part of progressional 1-st class perk information to progressional n-th class perk information, progressional 1-st class ultimate skill information to progressional n-th class ultimate skill information, and progressional 1-st class synergy item information to progressional n-th class synergy item information by matching at least part of each progressional k-th class perk information, each progressional k-th ultimate skill information, and each progressional k-th class synergy item information with the k-th class (while varying k from 1 to n), the server 100 may acquire the game participation request from the specific user device.

For reference, the progressional k-th class perk information may include at least one k-th class perk applied to the k-th players for each game-progression degree in the second state, the progressional k-th class ultimate skill information may include at least one k-th class ultimate skill applied to the k-th players for each game-progression degree in the second state, and the progressional k-th class synergy item information may include at least one k-th class synergy item applied to the k-th players for each game-progression degree in the second state.

Further, the server 100 may change at least part of the 1-st class perk to the n-th class perk, the 1-st class ultimate skill to the n-th class ultimate skill, and the 1-st class synergy item to the n-th class synergy item within the battle royale game by referring to at least part of 1-st class perk information to n-th class perk information, 1-st class ultimate skill information to n-th class ultimate skill information, and 1-st class synergy item information to n-th class synergy item information (corresponding to the current game-progression degree respectively) among the progressional 1-st class perk information to the progressional n-th class perk information, the progressional 1-st class ultimate skill information to the progressional n-th class ultimate skill information, and the progressional 1-st class synergy item information to the progressional n-th class synergy item information.

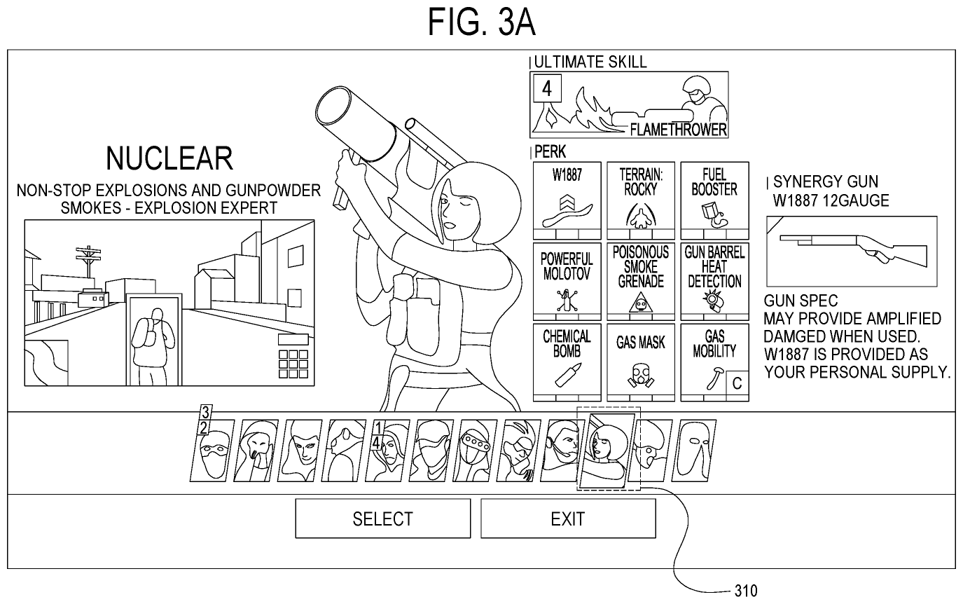

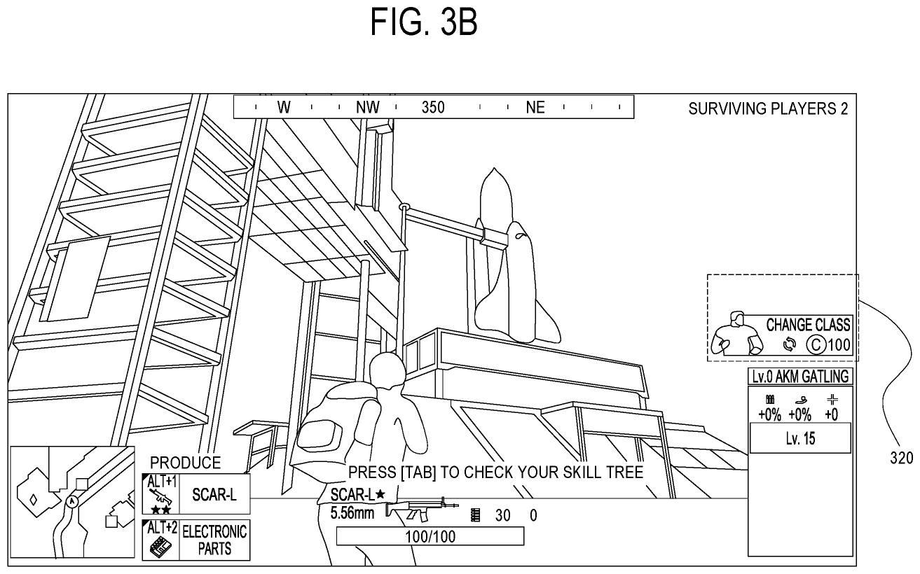

Hereinafter, how the specific class applied to the specific player corresponding to the specific user device is selected/changed will be exemplarily described with reference to FIGS. 3A and 3B.

First, by referring to FIGS. 3A and 3B, the server 100, in the first state, has determined 12 initial selectable classes by referring to at least part of the initial 1-st predetermined maximum player information to the initial n-th predetermined maximum player information and the 1-st standby player information to the n-th standby player information.

Further, as shown in FIG. 3A, when a nuclear class 310 is selected by the specific user device as the specific initial selectable class among the 12 initial selectable classes, the server 100 may apply the specific initial selectable class (that is, the nuclear class) to the specific player corresponding to the specific user device.

Meanwhile, the specific user device may change a current class applied to the specific player in the second state.

For instance, as shown in FIG. 3B, the server 100 may obtain a class change request from the specific user device by displaying a class change UI 320 on a display of the specific user device.

And, the server 100, through a process similar to that described with reference to FIG. 3A, may (i) support the specific user device to select the specific currently changeable class, or (ii) select the specific currently changeable class by using the predetermined second function, to thereby change the current class of the specific player to the specific currently changeable class.

The present disclosure has an effect of providing the battle royale game based on the plurality of classes by assigning each class to each player participating in the battle royale game.

The present disclosure has another effect of allowing each user participating in the battle royale game to break away from a uniform strategy centered on item collection, and to induce frequent battles.

The present disclosure has still another effect of enabling each user of the battle royale game to continuously have interest in the battle royale game.

The embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to a skilled human in a field of computer software. Program commands may include not only a machine language code made by a complier but also a high level code that can be used by an interpreter etc., which is executed by a computer. Program commands may include not only a machine language code made by a complier but also a high level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method of providing a battle royale game based on a plurality of classes, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, comprising steps of:
(a) on condition that at least one of (1) a process of matching initial k-th predetermined maximum player information with a k-th class while varying k from 1 to n, wherein the initial k-th predetermined maximum player information includes information on a maximum possible number of k-th players belonging to the k-th player group that exist simultaneously in the first state of the battle royale game, thereby setting initial 1-st predetermined maximum player information to initial n-th predetermined maximum player information corresponding to a 1-st class to an n-th class, and (2) a process of matching each progressional k-th predetermined maximum player information for each game-progression degree with the k-th class, wherein the progressional k-th predetermined maximum player information includes information on each maximum possible number of the k-th players belonging to the k-th player group that simultaneously exist for each game-progression degree in the second state of the battle royale game, and wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, thereby setting progressional 1-st predetermined maximum player information to progressional n-th predetermined maximum player information corresponding to the 1-st class to the n-th class have been performed, a server acquiring a game participation request for the battle royale game from a specific user device,
(b) on condition that the server has acquired at least part of 1-st standby player information to n-th standby player information in real-time, including k-th standby player information which includes a cardinal number of the k-th players belonging to the k-th player group in the first state, or at least part of 1-st surviving player information to n-th surviving player information in real-time, including k-th surviving player information which includes a cardinal number of k-th surviving players among the k-th players belonging to the k-th player group in the second state, the server performing one of a 1-st process and a 2-nd process,
wherein the 1-st process performs processes of: (i-1) determining initial selectable classes by referring to at least part of the initial 1-st predetermined maximum player information to the initial n-th predetermined maximum player information and the 1-st standby player information to the n-th standby player information in the first state, wherein the initial selectable classes are at least part of classes other than initial saturated classes among the 1-st class to the n-th class, and wherein a j-th class is determined as one of the initial saturated classes when a cardinal number of players of j-th standby player information reaches initial j-th predetermined maximum player information, (i-2) instructing the specific user device to perform one of (i-2-1) a (1_1)-st process of selecting a specific initial selectable class among the initial selectable classes and (i-2-2) a (1_2)-nd process of selecting the specific initial selectable class by using a predetermined first function with the initial selectable classes and their corresponding initial selectable probabilities as arguments, and (i-3) applying the specific initial selectable class to a specific player corresponding to the specific user device, and
wherein the 2-nd process performs processes of: (ii-1) determining currently changeable classes by referring to at least part of the 1-st surviving player information to the n-th surviving player information and 1-st predetermined maximum player information to n-th predetermined maximum player information corresponding to a current game-progression degree calculated by the progress calculating function in real time among the progressional 1-st predetermined maximum player information to the progressional n-th predetermined maximum player information in the second state, wherein the currently changeable classes are at least part of classes other tha currently saturated classes among the 1-st class to the n-th class, and wherein a j′-th class is determined as one of the currently saturated classes when a cardinal number of players of j′-th survival player information reaches progressional j′-th predetermined maximum player information (ii-2) instructing the specific user device to perform one of (ii-2-1) a (2_1)-st process of selecting a specific currently changeable class among the currently changeable classes and (ii-2-2) a (2_2)-nd process of selecting the specific currently changeable class by using a predetermined second function with the currently changeable classes and their corresponding currently changeable probabilities as arguments, and (ii-3) changing a class of the specific player to the specific currently changeable class.

2. The method of claim 1, wherein, at the step of (b), the server performs one of (i) the 1-st process of determining ml available initial selectable classes among the initial selectable classes by referring to a predetermined first algorithm in the first state, and performing one of (i-1) the (1_1)-st process of instructing the specific user device to select a specific available initial selectable class among the available initial selectable classes as the specific initial selectable class and (i-2) the (1_2)-nd process of selecting the specific available initial selectable class as the specific initial selectable class by using a predetermined third function whose arguments are the available initial selectable classes and their corresponding available initial selectable probabilities, to thereby apply the specific initial selectable class to the specific player, and (ii) the 2-nd process of determining m2 available currently changeable classes among the currently changeable classes by referring to a predetermined second algorithm in the second state, and performing one of (ii-1) the (2_1)-st process of instructing the specific user device to select a specific available currently changeable class among the available currently changeable classes as the specific currently changeable class and (ii-2) the (2_2)-nd process of selecting the specific available currently changeable class as the specific currently changeable class by using a predetermined fourth function whose arguments are the available currently changeable classes and their corresponding available currently changeable probabilities, to thereby apply the specific currently changeable class to the specific player.

3. The method of claim 1, wherein, at the step of (b), the server performs one of (i) the 1-st process of (i-1) determining m1-1 available initial selectable classes among the initial selectable classes by referring to a predetermined first algorithm in the first state, (i-2) in response to detecting that a re-determination request of selectable classes is acquired from the specific user device, checking whether a re-determination condition of selectable classes is satisfied by referring to (1_1)-st specific state information of the specific player, (i-3) in response to detecting that the re-determination condition for selectable classes is satisfied, determining m1_2 available adjustable selectable classes among the initial selectable classes by referring to the predetermined first algorithm, and (i-4) performing one of (i-4-a) the (1_1)-st process of instructing the specific user device to select a specific available adjustable selectable class among the available adjustable selectable classes as the specific initial selectable class and (i-4-b) the (1_2)-nd process of selecting the specific available adjustable selectable class as the specific initial selectable class by using a fifth function whose arguments are the available adjustable initial selectable classes and their corresponding available adjustable initial selectable probabilities, to thereby apply the specific available adjustable selectable class to the specific player, and (ii) the 2-nd process of (ii-1) determining m2_1 available currently changeable classes among the currently changeable classes by referring to a predetermined second algorithm in the second state, (ii-2) in response to detecting that a re-determination request of changeable classes is acquired from the specific user device, checking whether a re-determination condition of changeable classes is satisfied by referring to (1_2)-nd specific state information of the specific player, (ii-3) in response to detecting that the re-determination condition of changeable classes is satisfied, determining m2_2 available adjustable currently changeable classes among the currently changeable classes by referring to the predetermined second algorithm, and (ii-4) performing one of (ii-4-a) the (2_1)-nd process of instructing the specific user device to select a specific available adjustable currently changeable class among the available adjustable currently changeable classes as the specific currently changeable class and (ii-4-b) the (2_2)-nd process of selecting the specific available adjustable currently changeable class as the specific currently changeable class by using a predetermined sixth function whose arguments are the available adjustable currently changeable classes and their corresponding available adjustable currently changeable probabilities, to thereby apply the specific currently changeable class to the specific player.

4. The method of claim 1, wherein, at the step of (b), the server (i) in response to acquiring (1_1)-st process-related selection information corresponding to the (1_1)-st process from the specific user device, performs the (1_1)-st process and assigns a predetermined first penalty to the specific player, (ii) in response to acquiring (1_2)-nd process-related selection information corresponding to the (1_2)-nd process from the specific user device, performs the (1_2)-nd process and assigns a predetermined first reward to the specific player, (iii) in response to acquiring (2_1)-st process-related selection information corresponding to the (2_1)-st process from the specific user device, performs the (2_1)-st process and assigns a predetermined second penalty to the specific player, and (iv) in response to acquiring (2_2)-nd process-related selection information corresponding to the (2_2)-nd process from the specific user device, performs the (2_2)-nd process and assigns a predetermined second reward to the specific player.

5. The method of claim 1, wherein, at the step of (b), during the (1_2)-nd process, the server (i) selects the specific initial selectable class by using the predetermined first function whose arguments are the initial selectable classes and their corresponding initial selectable probabilities, (ii) in response to acquiring a class re-selection request from the specific user device, checks whether a class re-selection condition is satisfied by referring to (2_1)-st specific state information of the specific player, and (iii) in response to satisfying the class re-selection condition, selects a predetermined initial selectable class as the specific initial selectable class by using the predetermined first function, and
wherein, during the (2_2)-nd process, the server (i) selects the specific currently changeable class by using the specific second function whose arguments are the currently changeable classes and their corresponding currently changeable probabilities, (ii) in response to acquiring a class re-change request from the specific user device, checks whether a class re-change condition is satisfied by referring to (2_2)-nd specific state information of the specific player, and (iii) in response to satisfying the class re-change condition, selects a predetermined currently changeable class as the specific currently changeable class by using the predetermined second function.

6. The method of claim 1, wherein, at the step of (a), on condition that the server has additionally performed at least one of processes of (i) setting a 1-st class perk to an n-th class perk corresponding to the 1-st class to the n-th class by matching a k-th class perk with the k-th class, wherein the k-th class perk is a special ability applied to the k-th players belonging to the k-th player group, (ii) setting a 1-st class ultimate skill to an n-th class ultimate skill corresponding to the 1-st class to the n-th class by matching a k-th class ultimate skill with the k-th class, and (iii) setting a 1-st class synergy item to an n-th class synergy item corresponding to the 1-st class to the n-th class by matching a k-th class synergy item with the k-th class, wherein the k-th class synergy item is an item that enhances any item used by the k-th players used within the battle royale game, the server acquires the game participation request from the specific user device, and
wherein, at the step of (b), during the 1-st process, the server applies a g-th class, which is the specific initial selectable class, to the specific player to thus (i) determine at least one of (1) at least one specific g-th class perk selected by using a predetermined (7_1)-st function whose arguments are at least one g-th class perk and its corresponding g-th class perk probability corresponding to the g-th class, (2) at least one specific g-th class ultimate skill selected by using a predetermined (7_2)-nd function whose arguments are at least one g-th class ultimate skill and its corresponding g-th class ultimate skill probability corresponding to the g-th class, and (3) at least one specific g-th class synergy item selected by using a predetermined (7_3)-rd function whose arguments are at least one g-th class synergy item and its corresponding g-th class synergy item probability corresponding to the g-th class, and (ii) set at least one of the specific g-th class perk, the specific g-th class ultimate skill, and the specific g-th class synergy item to correspond to the specific player, and wherein, at the step of (b), during the 2-nd process, the server changes the class of the specific player to an h-th class, which is the specific currently changeable class, to thus (i) determine at least one of (1) at least one specific h-th class perk selected by using a predetermined (8_1)-st function whose arguments are at least one h-th class perk and its corresponding h-th class perk probability corresponding to the h-th class, (2) at least one specific h-th class ultimate skill selected by using a predetermined (8_2)-nd function whose arguments are at least one h-th class ultimate skill and its corresponding h-th class ultimate skill probability corresponding to the h-th class, and (3) at least one specific h-th class synergy item selected by using a predetermined (8_3)-rd function whose arguments are at least one h-th class synergy item and its corresponding h-th class synergy item probability corresponding to the h-th class, and (ii) change at least one of current class perk, current ultimate skill, and current class synergy item of the specific player to at least one of the specific h-th class perk, the specific h-th class ultimate skill, and the specific h-th class synergy item.

7. The method of claim 1, wherein, at the step of (a), on condition that the server has additionally performed at least one of processes of (i) setting a 1-st class perk to an n-th class perk respectively corresponding to the 1-st class to the n-th class by matching at least one k-th class perk with the k-th class, wherein the k-th class perk is a special ability applied to the k-th players belonging to the k-th player group, (ii) setting a 1-st class ultimate skill to an n-th class ultimate skill respectively corresponding to the 1-st class to the n-th class by matching a k-th class ultimate skill with the k-th class, and (iii) setting a 1-st class synergy item to an n-th class synergy item respectively corresponding to the 1-st class to the n-th class by matching a k-th class synergy item with the k-th class, wherein the k-th class synergy item is an item that enhances any item used by the k-th players used within the battle royale game, the server acquires the game participation request from the specific user device, and
wherein, at the step of (b), during the (1_1)-st process, the server provides information on (i) an initial selectable class perk, among the 1-st class perk to the n-th class perk, corresponding to the initial selectable class, (ii) an initial selectable class ultimate skill, among the 1-st class ultimate skill to the n-th class ultimate skill, corresponding to the initial selectable class, and (iii) an initial selectable class synergy item, among the 1-st class synergy item to the n-th class synergy item, corresponding to the initial selectable class, to the specific user device, to thereby instruct the specific user device to select the specific initial selectable class by referring to at least part of the information on the initial selectable class perk, the initial selectable class ultimate skill, and the initial selectable class synergy item, and
wherein, at the step of (b), during the (2_1)-st process, the server provides information on (i) a currently changeable class perk, among the 1-st class perk to the n-th class perk, corresponding to the currently changeable class, (ii) a currently changeable class ultimate skill, among the 1-st class ultimate skill to the n-th class ultimate skill, corresponding to the currently changeable class, and (iii) a currently changeable class synergy item, among the 1-st class synergy item to the n-th class synergy item, corresponding to the currently changeable class, to the specific user device, to thereby instruct the specific user device to select the specific currently changeable class by referring to at least part of the information on the currently changeable class perk, the currently changeable class ultimate skill, and the currently changeable class synergy item.

8. The method of claim 1, wherein, at the step of (b), during the (1_1)-st process, in response to receiving a request for standby player information from the specific user device, the server provides at least part of the 1-st standby player information to the n-th standby player information to the specific user device, to thereby instruct the specific user device to select the specific initial selectable class by referring to at least part of the 1-st standby player information to the n-th standby player information, and
wherein, at the step of (b), during the (2_1)-st process, in response to receiving a request for surviving player information from the specific user device, the server provides at least part of the 1-st surviving player information to the n-th surviving player information to the specific user device, to thereby instruct the specific user device to select the specific currently changeable class by referring to at least part of the 1-st surviving player information to the n-th surviving player information.

9. The method of claim 1, wherein, at the step of (a), on condition that the server has performed processes of matching at least part of progressional k-th available item information and progressional k-th item performance information for each game-progression degree with the k-th class, wherein the progressional k-th available item information includes usable items of the k-th players for each game-progression degree and the progressional k-th item performance information includes performance information of the usable items of the k-th players for each game-progression degree, to thereby set at least part of progressional 1-st available item information to progrsesional n-th available item information and progressional 1-st item performance information to progressional n-th item performance information, the server acquires the game participation request from the specific user device, and
wherein the method further includes a step of:
(c) the server changing at least part of an item type and an item performance of the usable item within the battle royale game by referring to at least part of 1-st available item information to n-th available item information and 1-st item performance information to n-th item performance information corresponding to the current game-progression degree among the progressional 1-st available item information to the progressional n-th available item information and the progrsesional 1-st item performance information to the progrssional n-th item performance information.

10. The method of claim 1, wherein, at the step of (a), on condition that the server has additionally performed a process of setting at least part of progressional 1-st class perk information to progressional n-th class perk information, progressional 1-st class ultimate skill information to progressional n-th class ultimate skill information, and progrsesional 1-st class synergy item information to progressional n-th class synergy item information by matching at least part of each progressional k-th class perk information, each progressional k-th ultimate skill information, and each progrssional k-th class synergy item information with the k-th class, wherein the progressional k-th class perk information includes at least one k-th class perk applied to the k-th players for each game-progression degree in the second state, the progressional k-th class ultimate skill information includes at least one k-th class ultimate skill applied to the k-th players for each game-progression degree in the second state, and the progressional k-th class synergy item information includes at least one k-th class synergy item applied to the k-th players for each game-progression degree in the second state, the server acquires the game participation request from the specific user device, and
wherein the method further includes a step of:
(d) the server changing at least part of the 1-st class perk to the n-th class perk, the 1-st class ultimate skill to the n-th class ultimate skill, and the 1-st class synergy item to the n-th class synergy item within the battle royale game by referring to at least part of 1-st class perk information to n-th class perk information, 1-st class ultimate skill information to n-th class ultimate skill information, and 1-st class synergy item information to n-th class synergy item information corresponding to the current game-progression degree respectively among the progressional 1-st class perk information to the progressional n-th class perk information, the progressional 1-st class ultimate skill information to the progressoinal n-th class ultimate skill information, and the progressional 1-st class synergy item information to the progressoinal n-th class synergy item information.

11. A server for providing a battle royale game based on a plurality of classes, wherein the battle royale game is a game in which a plurality of players compete for survival in a specific area, wherein a first state of the battle royale game represents a standby state in which the players log into the battle royale game and wait in a same waiting space and wherein a second state of the battle royale game represents a state in which the players play the battle royale game, comprising:
at least one memory that stores instructions; and
at least one processor configured to execute the instruction to perform or support another device to perform: (I) on condition that at least one of (1) a process of matching initial k-th predetermined maximum player information with a k-th class while varying k from 1 to n, wherein the initial k-th predetermined maximum player information includes information on a maximum possible number of k-th players belonging to the k-th player group that exist simultaneously in the first state of the battle royale game, thereby setting initial 1-st predetermined maximum player information to initial n-th predetermined maximum player information corresponding to a 1-st class to an n-th class, and (2) a process of matching each progressional k-th predetermined maximum player information for each game-progression degree with the k-th class, wherein the progressional k-th predetermined maximum player information includes information on each maximum possible number of the k-th players belonging to the k-th player group that simultaneously exist for each game-progression degree in the second state of the battle royale game, and wherein the game-progression degree is calculated by using a progress calculating function whose arguments include at least part of (i) elapsed time information which represents a time elapsed after the battle royale game enters the second state, (ii) player battle power information which represents battle powers of at least part of the plurality of players, (iii) a cardinal number of surviving players among the plurality of players, (iv) area phase information which represents a state of a safe area and a dangerous area being changed according to area metadata, and (v) possessed items of the surviving players, thereby setting progressional 1-st predetermined maximum player information to progressional n-th predetermined maximum player information corresponding to the 1-st class to the n-th class have been performed, acquiring a game participation request for the battle royale game from a specific user device, (II) on condition that at least part of 1-st standby player information to n-th standby player information in real-time, including k-th standby player information which includes a cardinal number of the k-th players belonging to the k-th player group in the first state, has been acquired or at least part of 1-st surviving player information to n-th surviving player information in real-time, including k-th surviving player information which includes a cardinal number of k-th surviving players among the k-th players belonging to the k-th player group in the second state, has been acquired, performing one of a 1-st process and a 2-nd process, wherein the 1-st process performs processes of: (i-1) determining initial selectable classes by referring to at least part of the initial 1-st predetermined maximum player information to the initial n-th predetermined maximum player information and the 1-st standby player information to the n-th standby player information in the first state, wherein the initial selectable classes are at least part of classes other than initial saturated classes among the 1-st class to the n-th class, and wherein a j-th class is determined as one of the initial saturated classes when a cardinal number of players of j-th standby player information reaches initial j-th predetermined maximum player information, (i-2) instructing the specific user device to perform one of (i-2-1) a (1_1)-st process of selecting a specific initial selectable class among the initial selectable classes and (i-2-2) a (1_2)-nd process of selecting the specific initial selectable class by using a predetermined first function with the initial selectable classes and their corresponding initial selectable probabilities as arguments, and (i-3) applying the specific initial selectable class to a specific player corresponding to the specific user device, and wherein the 2-nd process performs processes of: (ii-1) determining currently changeable classes by referring to at least part of the 1-st surviving player information to the n-th surviving player information and 1-st predetermined maximum player information to n-th predetermined maximum player information corresponding to a current game-progression degree calculated by the progress calculating function in real time among the progressional 1-st predetermined maximum player information to the progressional n-th predetermined maximum player information in the second state, wherein the currently changeable classes are at least part of classes other tha currently saturated classes among the 1-st class to the n-th class, and wherein a j′-th class is determined as one of the currently saturated classes when a cardinal number of players of j′-th survival player information reaches progressional j′-th predetermined maximum player information (ii-2) instructing the specific user device to perform one of (ii-2-1) a (2_1)-st process of selecting a specific currently changeable class among the currently changeable classes and (ii-2-2) a (2_2)-nd process of selecting the specific currently changeable class by using a predetermined second function with the currently changeable classes and their corresponding currently changeable probabilities as arguments, and (ii-3) changing a class of the specific player to the specific currently changeable class.

12. The server of claim 11, wherein, at the process of (II), the processor performs one of (i) the 1-st process of determining ml available initial selectable classes among the initial selectable classes by referring to a predetermined first algorithm in the first state, and performing one of (i-1) the (1_1)-st process of instructing the specific user device to select a specific available initial selectable class among the available initial selectable classes as the specific initial selectable class and (i-2) the (1_2)-nd process of selecting the specific available initial selectable class as the specific initial selectable class by using a predetermined third function whose arguments are the available initial selectable classes and their corresponding available initial selectable probabilities, to thereby apply the specific initial selectable class to the specific player, and (ii) the 2-nd process of determining m2 available currently changeable classes among the currently changeable classes by referring to a predetermined second algorithm in the second state, and performing one of (ii-1) the (2_1)-st process of instructing the specific user device to select a specific available currently changeable class among the available currently changeable classes as the specific currently changeable class and (ii-2) the (2_2)-nd process of selecting the specific available currently changeable class as the specific currently changeable class by using a predetermined fourth function whose arguments are the available currently changeable classes and their corresponding available currently changeable probabilities, to thereby apply the specific currently changeable class to the specific player.

13. The server of claim 11, wherein, at the process of (II), the processor performs one of (i) the 1-st process of (i-1) determining m1-1 available initial selectable classes among the initial selectable classes by referring to a predetermined first algorithm in the first state, (i-2) in response to detecting that a re-determination request of selectable classes is acquired from the specific user device, checking whether a re-determination condition of selectable classes is satisfied by referring to (1_1)-st specific state information of the specific player, (i-3) in response to detecting that the re-determination condition for selectable classes is satisfied, determining m1_2 available adjustable selectable classes among the initial selectable classes by referring to the predetermined first algorithm, and (i-4) performing one of (i-4-a) the (1_1)-st process of instructing the specific user device to select a specific available adjustable selectable class among the available adjustable selectable classes as the specific initial selectable class and (i-4-b) the (1_2)-nd process of selecting the specific available adjustable selectable class as the specific initial selectable class by using a fifth function whose arguments are the available adjustable initial selectable classes and their corresponding available adjustable initial selectable probabilities, to thereby apply the specific available adjustable selectable class to the specific player, and (ii) the 2-nd process of (ii-1) determining m2_1 available currently changeable classes among the currently changeable classes by referring to a predetermined second algorithm in the second state, (ii-2) in response to detecting that a re-determination request of changeable classes is acquired from the specific user device, checking whether a re-determination condition of changeable classes is satisfied by referring to (1_2)-nd specific state information of the specific player, (ii-3) in response to detecting that the re-determination condition of changeable classes is satisfied, determining m2_2 available adjustable currently changeable classes among the currently changeable classes by referring to the predetermined second algorithm, and (ii-4) performing one of (ii-4-a) the (2_1)-nd process of instructing the specific user device to select a specific available adjustable currently changeable class among the available adjustable currently changeable classes as the specific currently changeable class and (ii-4-b) the (2_2)-nd process of selecting the specific available adjustable currently changeable class as the specific currently changeable class by using a predetermined sixth function whose arguments are the available adjustable currently changeable classes and their corresponding available adjustable currently changeable probabilities, to thereby apply the specific currently changeable class to the specific player.

14. The server of claim 11, wherein, at the process of (II), the processor (i) in response to acquiring (1_1)-st process-related selection information corresponding to the (1_1)-st process from the specific user device, performs the (1_1)-st process and assigns a predetermined first penalty to the specific player, (ii) in response to acquiring (1_2)-nd process-related selection information corresponding to the (1_2)-nd process from the specific user device, performs the (1_2)-nd process and assigns a predetermined first reward to the specific player, (iii) in response to acquiring (2_1)-st process-related selection information corresponding to the (2_1)-st process from the specific user device, performs the (2_1)-st process and assigns a predetermined second penalty to the specific player, and (iv) in response to acquiring (2_2)-nd process-related selection information corresponding to the (2_2)-nd process from the specific user device, performs the (2_2)-nd process and assigns a predetermined second reward to the specific player.

15. The server of claim 11, wherein, at the process of (II), during the (1_2)-nd process, the processor (i) selects the specific initial selectable class by using the predetermined first function whose arguments are the initial selectable classes and their corresponding initial selectable probabilities, (ii) in response to acquiring a class re-selection request from the specific user device, checks whether a class re-selection condition is satisfied by referring to (2_1)-st specific state information of the specific player, and (iii) in response to satisfying the class re-selection condition, selects a predetermined initial selectable class as the specific initial selectable class by using the predetermined first function, and wherein, during the (2_2)-nd process, the processor (i) selects the specific currently changeable class by using the specific second function whose arguments are the currently changeable classes and their corresponding currently changeable probabilities, (ii) in response to acquiring a class re-change request from the specific user device, checks whether a class re-change condition is satisfied by referring to (2_2)-nd specific state information of the specific player, and (iii) in response to satisfying the class re-change condition, selects a predetermined currently changeable class as the specific currently changeable class by using the predetermined second function.

16. The server of claim 11, wherein, at the process of (I), on condition that the processor has additionally performed at least one of processes of (i) setting a 1-st class perk to an n-th class perk corresponding to the 1-st class to the n-th class by matching a k-th class perk with the k-th class, wherein the k-th class perk is a special ability applied to the k-th players belonging to the k-th player group, (ii) setting a 1-st class ultimate skill to an n-th class ultimate skill corresponding to the 1-st class to the n-th class by matching a k-th class ultimate skill with the k-th class, and (iii) setting a 1-st class synergy item to an n-th class synergy item corresponding to the 1-st class to the n-th class by matching a k-th class synergy item with the k-th class, wherein the k-th class synergy item is an item that enhances any item used by the k-th players used within the battle royale game, the processor acquires the game participation request from the specific user device, and wherein, at the process of (II), during the 1-st process, the processor applies a g-th class, which is the specific initial selectable class, to the specific player to thus (i) determine at least one of (1) at least one specific g-th class perk selected by using a predetermined (7_1)-st function whose arguments are at least one g-th class perk and its corresponding g-th class perk probability corresponding to the g-th class, (2) at least one specific g-th class ultimate skill selected by using a predetermined (7_2)-nd function whose arguments are at least one g-th class ultimate skill and its corresponding g-th class ultimate skill probability corresponding to the g-th class, and (3) at least one specific g-th class synergy item selected by using a predetermined (7_3)-rd function whose arguments are at least one g-th class synergy item and its corresponding g-th class synergy item probability corresponding to the g-th class, and (ii) set at least one of the specific g-th class perk, the specific g-th class ultimate skill, and the specific g-th class synergy item to correspond to the specific player, and wherein, at the process of (II), during the 2-nd process, the processor changes the class of the specific player to an h-th class, which is the specific currently changeable class, to thus (i) determine at least one of (1) at least one specific h-th class perk selected by using a predetermined (8_1)-st function whose arguments are at least one h-th class perk and its corresponding h-th class perk probability corresponding to the h-th class, (2) at least one specific h-th class ultimate skill selected by using a predetermined (8_2)-nd function whose arguments are at least one h-th class ultimate skill and its corresponding h-th class ultimate skill probability corresponding to the h-th class, and (3) at least one specific h-th class synergy item selected by using a predetermined (8_3)-rd function whose arguments are at least one h-th class synergy item and its corresponding h-th class synergy item probability corresponding to the h-th class, and (ii) change at least one of current class perk, current ultimate skill, and current class synergy item of the specific player to at least one of the specific h-th class perk, the specific h-th class ultimate skill, and the specific h-th class synergy item.

17. The server of claim 11, wherein, at the process of (I), on condition that the processor has additionally performed at least one of processes of (i) setting a 1-st class perk to an n-th class perk respectively corresponding to the 1-st class to the n-th class by matching at least one k-th class perk with the k-th class, wherein the k-th class perk is a special ability applied to the k-th players belonging to the k-th player group, (ii) setting a 1-st class ultimate skill to an n-th class ultimate skill respectively corresponding to the 1-st class to the n-th class by matching a k-th class ultimate skill with the k-th class, and (iii) setting a 1-st class synergy item to an n-th class synergy item respectively corresponding to the 1-st class to the n-th class by matching a k-th class synergy item with the k-th class, wherein the k-th class synergy item is an item that enhances any item used by the k-th players used within the battle royale game, the processor acquires the game participation request from the specific user device, and wherein, at the process of (II), during the (1_1)-st process, the processor provides information on (i) an initial selectable class perk, among the 1-st class perk to the n-th class perk, corresponding to the initial selectable class, (ii) an initial selectable class ultimate skill, among the 1-st class ultimate skill to the n-th class ultimate skill, corresponding to the initial selectable class, and (iii) an initial selectable class synergy item, among the 1-st class synergy item to the n-th class synergy item, corresponding to the initial selectable class, to the specific user device, to thereby instruct the specific user device to select the specific initial selectable class by referring to at least part of the information on the initial selectable class perk, the initial selectable class ultimate skill, and the initial selectable class synergy item, and wherein, at the process of (II), during the (2_1)-st process, the processor provides information on (i) a currently changeable class perk, among the 1-st class perk to the n-th class perk, corresponding to the currently changeable class, (ii) a currently changeable class ultimate skill, among the 1-st class ultimate skill to the n-th class ultimate skill, corresponding to the currently changeable class, and (iii) a currently changeable class synergy item, among the 1-st class synergy item to the n-th class synergy item, corresponding to the currently changeable class, to the specific user device, to thereby instruct the specific user device to select the specific currently changeable class by referring to at least part of the information on the currently changeable class perk, the currently changeable class ultimate skill, and the currently changeable class synergy item.

18. The server of claim 11, wherein, at the process of (II), during the (1_1)-st process, in response to receiving a request for standby player information from the specific user device, the processor provides at least part of the 1-st standby player information to the n-th standby player information to the specific user device, to thereby instruct the specific user device to select the specific initial selectable class by referring to at least part of the 1-st standby player information to the n-th standby player information, and wherein, at the process of (II), during the (2_1)-st process, in response to receiving a request for surviving player information from the specific user device, the processor provides at least part of the 1-st surviving player information to the n-th surviving player information to the specific user device, to thereby instruct the specific user device to select the specific currently changeable class by referring to at least part of the 1-st surviving player information to the n-th surviving player information.

19. The server of claim 11, wherein, at the process of (I), on condition that the processor has performed processes of matching at least part of progressional k-th available item information and progressional k-th item performance information for each game-progression degree with the k-th class, wherein the progressional k-th available item information includes usable items of the k-th players for each game-progression degree and the progressional k-th item performance information includes performance information of the usable items of the k-th players for each game-progression degree, to thereby set at least part of progressional 1-st available item information to progrsesional n-th available item information and progressional 1-st item performance information to progressional n-th item performance information, the processor acquires the game participation request from the specific user device, and wherein the processor further performs a process of: (III) changing at least part of an item type and an item performance of the usable item within the battle royale game by referring to at least part of 1-st available item information to n-th available item information and 1-st item performance information to n-th item performance information corresponding to the current game-progression degree among the progressional 1-st available item information to the progressional n-th available item information and the progrsesional 1-st item performance information to the progrssional n-th item performance information.

20. The server of claim 11, wherein, at the process of (I), on condition that the processor has additionally performed a process of setting at least part of progressional 1-st class perk information to progressional n-th class perk information, progressional 1-st class ultimate skill information to progressional n-th class ultimate skill information, and progrsesional 1-st class synergy item information to progressional n-th class synergy item information by matching at least part of each progressional k-th class perk information, each progressional k-th ultimate skill information, and each progrssional k-th class synergy item information with the k-th class, wherein the progressional k-th class perk information includes at least one k-th class perk applied to the k-th players for each game-progression degree in the second state, the progressional k-th class ultimate skill information includes at least one k-th class ultimate skill applied to the k-th players for each game-progression degree in the second state, and the progressional k-th class synergy item information includes at least one k-th class synergy item applied to the k-th players for each game-progression degree in the second state, the processor acquires the game participation request from the specific user device, and wherein the processor further performs a process of: (IV) changing at least part of the 1-st class perk to the n-th class perk, the 1-st class ultimate skill to the n-th class ultimate skill, and the 1-st class synergy item to the n-th class synergy item within the battle royale game by referring to at least part of 1-st class perk information to n-th class perk information, 1-st class ultimate skill information to n-th class ultimate skill information, and 1-st class synergy item information to n-th class synergy item information corresponding to the current game-progression degree respectively among the progressional 1-st class perk information to the progressional n-th class perk information, the progressional 1-st class ultimate skill information to the progressoinal n-th class ultimate skill information, and the progressional 1-st class synergy item information to the progressoinal n-th class synergy item information.
